(19) United States
(12) Patent Application Publication
(10) Pub. No.: US 2025/0096308 A1
(43) Pub. Date: Mar. 20, 2025

(54) ELECTROLYTE, ELECTRODE ASSEMBLY, AND BATTERY COMPRISING SAME

(71) Applicant: LG ENERGY SOLUTION, LTD., Seoul (KR)

(72) Inventors: Sung Hyun NAM, Daejeon (KR); Dong Kyu Kim, Daejeon (KR)

(21) Appl. No.: 18/885,146

(22) Filed: Sep. 13, 2024

(30) Foreign Application Priority Data
Sep. 15, 2023 (KR) 10-2023-0123075
Apr. 2, 2024 (KR) 10-2024-0044702
Apr. 11, 2024 (KR) 10-2024-0048814
Sep. 11, 2024 (KR) 10-2024-0123904
Sep. 11, 2024 (KR) 10-2024-0123905
Sep. 11, 2024 (KR) 10-2024-0123906
Sep. 11, 2024 (KR) 10-2024-0123907

(51) Int. Cl. H01M 10/056; H01M 50/446

(52) U.S. Cl. CPC H01M 10/056; H01M 50/446; H01M 2300/0065

(57) ABSTRACT

An electrolyte, a battery comprising the same, and a method for producing the same are provided. The electrolyte includes: a polymer formed from a polyethylene oxide (PEO)-based copolymer containing crosslinkable functional groups; a ceramic compound; and a polar compound, wherein at least some of the crosslinkable functional groups of the PEO-based copolymer containing crosslinkable functional groups form crosslinks with each other.

### REFERENCE TO RELATED APPLICATIONS

The present application claims priority to and the benefit of Korean patent application no. KR 10-2023-0123075 filed on Sep. 15, 2023, Korean patent application no. KR 10-2024-0044702 filed on Apr. 2, 2024, Korean patent application no. KR 10-2024-0048814 filed on Apr. 11, 2024, Korean patent application no. KR 10-2024-0123904 filed on Sep. 11, 2024, Korean patent application no. KR 10-2024-0123905 filed on Sep. 11, 2024, Korean patent application no. KR 10-2024-0123906 filed on Sep. 11, 2024 and Korean patent application no. KR 10-2024-0123907 filed on Sep. 11, 2024, the entire contents of which are incorporated herein by reference.

### TECHNICAL FIELD

The present invention relates to an electrolyte, an electrode assembly comprising the electrolyte, a battery comprising the electrolyte, and a method for producing the same.

### BACKGROUND ART

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

Lithium-ion batteries that use a liquid electrolyte have a structure in which the positive electrode and the negative electrode are divided by a separator, so if the separator is damaged by deformation or external impact, a short circuit may occur, which can lead to risks such as overheating or explosion. Therefore, the development of a solid electrolyte that can ensure safety in the field of lithium-ion secondary batteries can be said to be a very important task.

Lithium secondary batteries using solid electrolytes have the advantage of increasing the safety of the battery, improving the reliability of the battery by preventing electrolyte leakage, and making it easy to manufacture thin batteries. In addition, lithium metal can be used as a negative electrode, which can improve energy density. Accordingly, it is expected to be applied to small secondary batteries as well as high-capacity secondary batteries, such as those for electric vehicles, and is attracting attention as a next-generation battery.

Among solid electrolytes, polymer solid electrolytes can be made of ion-conducting polymer materials, and can optionally be used in the form of a solid electrolyte that mixes these polymer materials with inorganic materials.

A conventional solid electrolyte is manufactured by dispersing inorganic powders such as oxide-based ceramics in a polymer matrix. Such a conventional solid electrolyte has higher ignition and combustion stability, and has higher ion resistance, compared to existing liquid electrolytes and polymer solid electrolytes. Although having the advantage of conductivity, the oxide-based ceramic particles within the polymer matrix can exhibit difficulties with dispersibility and optimization of the physical properties of the polymer matrix. In particular, when using a highly crystalline polymer such as polyethylene oxide (PEO) as a matrix, there is a problem in that it is difficult to manufacture a solid electrolyte with improved ionic conductivity. In other words, due to the high crystallinity of the PEO polymer, the chain mobility of the polymer is inhibited and there are restrictions on the movement of lithium ions inside the polymer solid electrolyte. As a result, there has been a limitation to improvement of the ionic conductivity of the polymer solid electrolyte.

In particular, such limitation to the improvement of the ionic conductivity of the polymer solid electrolyte emerged more clearly at low temperatures, and as a result, it has been a large limiting factor in developing a solid-state battery capable of operating at a low temperature. Accordingly, there has been a continuous need to develop a composite solid electrolyte having excellent ionic conductivity at the low temperature of 0° C. or less.

### SUMMARY

Aspects of the present disclosure provide an electrolyte showing improved ionic conductivity, as well as other benefits and advantages that will be apparent to those persons skilled in the art based on the present disclosure. The present disclosure also includes a solid electrolyte, a composite electrolyte, as well as a composite solid electrolyte, formed with the inventive electrolyte. In addition, the present disclosure includes a method for making the inventive electrolyte, as well as a battery incorporating the electrolyte exhibiting improved ionic conductivity and other beneficial properties and functionality.

It should be understood that the various individual aspects and features of the present disclosure described herein can be combined with any one or more individual aspect or feature, in any number, to form embodiments of the present disclosure that are specifically contemplated and encompassed by the present disclosure. This includes any combination of the various features recited in the claims, regardless of their stated dependencies.

According to certain aspects, there is provided an electrolyte comprising: a polymer formed of a polyethylene oxide (PEO)-based copolymer containing crosslinkable functional groups; a ceramic compound; and a polar compound, wherein at least some of the crosslinkable functional groups of the PEO-based copolymer containing crosslinkable functional groups form crosslinks with each other.

According to certain aspects, there is provided an electrolyte comprising: a polymer mixture including a polyethylene(PEO)-based copolymer containing crosslinkable functional groups and a non-crosslinkable PEO-based copolymer; a ceramic compound; and a polar compound, wherein at least some of the crosslinkable functional groups of the PEO-based copolymer containing crosslinkable functional groups form crosslinks with each other, wherein the polar compound is contained in the polymer mixture. According to certain embodiments, the electrolyte optionally has an ionic conductivity of 0.15 mS/cm or higher at a temperature of −30° C. or higher.

According to certain embodiments, the electrolyte comprises a weight ratio of the non-crosslinkable PEO-based copolymer to a total weight of the polymer mixture is optionally more than 0 and 0.55 or less.

According to certain embodiments, the electrolyte comprises a content of the polar compound that is optionally 0.1% by weight or more and less than 10% by weight based on a total weight of the electrolyte.

According to certain embodiments, electrolyte comprises the PEO-based copolymer containing crosslinkable functional groups that is optionally in the form of a network structure formed by the crosslinks, and wherein the polar compound is contained in the network structure.

According to certain embodiments, the electrolyte optionally further comprises a crosslinking agent.

According to certain embodiments, at least some of the crosslinkable functional groups in the PEO-based copolymer form the crosslinks with each other through the crosslinking agent.

According to certain embodiments, the electrolyte comprises the crosslinking agent that optionally comprises one or more selected from the group consisting of trimethylolpropane trimethacrylate, poly(ethylene glycol) diacrylate, poly(ethylene glycol) dimethacrylate, ethylene glycol dimethylacrylate, (EGDMA), 1,3-diisopropenylbenzene (DIP), 1,4-diacryloyl piperazine, 2-(diethylamino)ethyl methacrylate, 2,6-bisacryloylamidopyridine, 3-(acryloyloxy)-2-hydroxypropyl methacrylate, 3,5-bis(acryloylamido)benzoic acid, 3-aminopropyltriethoxysilane, 3-isocyanatopropyltriethoxysilane, 3-methylacryloxypropyl trimethoxysilane, bis-(1-(tert-butylperoxy)-1-methylethyl)-benzene, dicumyl peroxide, dimethacrylate, divinylbenzene, ethylene glycol maleic rosinate acrylate, glycidilmethacrylate, hydroxyquinoline, i-phenyldiethoxysilane, maleic rosin glycol acrylate), methylene bisacrylamide, N,N′-1,4-phenylenediacrylamine), N,O-bisacryloyl-phenylalaninol), N,O-bismethacryloyl ethanolamine, pentaerythritol triacrylate, phenyltrimethoxy silane, tetramethoxysilane, tetramethylene, tetraethoxysilane, and triallyl isocyanurate.

According to certain embodiments, the electrolyte comprises crosslinkable functional groups that are optionally connected to a main chain of the PEO-based copolymer via a direct bond or a linker having 1 to 10 carbon number, and wherein the cross linkable functional groups are selected from the group consisting of a hydroxyl group, a carboxyl group, an isocyanate group, a nitro group, a cyano group, an amine group, an amide group, an epoxy group, and an allyl group.

According to certain embodiments, the electrolyte optionally further includes a lithium salt.

According to certain embodiments, the lithium salt is optionally included in the electrolyte in an amount of 25 to 45 parts by weight, based on 100 parts by weight of the PEO-based copolymer containing the crosslinkable functional group.

According to certain embodiments, a weight ratio of the PEO-based copolymer containing crosslinkable functional groups to the non-crosslinkable PEO-based copolymer in the electrolyte is optionally 5:5 to 9:1.

According to certain embodiments, the electrolyte comprises the PEO-based copolymer containing crosslinkable functional groups that is optionally a copolymer having repeating units of the following Formulas 1 to 3:

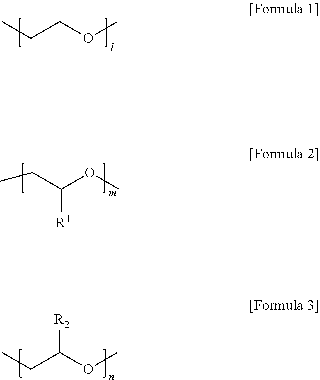

wherein, in Formulas 1 to 3, R₁ is —CH₂—O—(CH₂—CH₂—O)ₖ—R₃, k is 0 to 20, and R₃ is an alkyl group having 1 to 5 carbon atoms, R₂ is a group in which one or more crosslinkable functional groups selected from the group consisting of a hydroxyl group, a carboxyl group, an isocyanate group, a nitro group, a cyano group, an amine group, and an amide group, an epoxy group and an allyl group are bonded to a main chain of the PEO-based copolymer via a direct bond or a linker having 1 to 10 carbon number, l, m, and n are the number of the repeating units, where 1 and n are each independently an integer from 1 to 100,000, and m is an integer from 0 to 100,000.

According to certain embodiments, the linker is optionally an alkylene linker or an alkylene oxide linker.

According to certain embodiments, the electrolyte comprises the non-crosslinkable PEO-based copolymer that is optionally a copolymer having repeating units of the following Formulas 1 and 2:

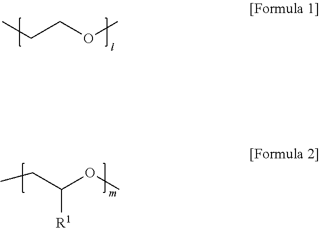

wherein, in Formulas 1 and 2, R₁ is —CH₂—O—(CH₂—CH₂—O)ₖ—R₃, k is 0 to 20, and R₃ is an alkyl group having 1 to 5 carbon atoms, l and m are the number of the repeating units, and are each independently an integer from 1 to 100,000.

According to certain embodiments, each of the PEO-based copolymer containing crosslinkable functional groups and the non-crosslinkable PEO-based copolymer optionally have a weight average molecular weight (Mw) of 100,000 g/mol to 4,000,000 g/mol.

According to certain embodiments, the polar compound optionally includes one or more selected from the group consisting of a carbonate-based compound and a sulfonyl-based compound.

According to certain embodiments, the polar compound optionally comprises one or more selected from the group consisting of ethyl methyl carbonate (EMC), dimethyl carbonate (DMC), diethyl carbonate (DEC), ethylene carbonate (EC), propylene carbonate (PC), vinylene carbonate (VC), and sulfolane.

According to certain embodiments, the ceramic compound optionally comprises an oxide-based solid electrolyte of lithium metal oxide or lithium metal phosphate.

According to certain embodiments, the ceramic compound optionally comprises one or more selected from the group consisting of a lithium-lanthanum-zirconium oxide (LLZO) compound, a lithium-silicon-titanium phosphate based (LSTP) compound, a lithium-lanthanum-titanium oxide based (LLTO) compound, a lithium-aluminum-titanium phosphate based (LATP) compound, a lithium-aluminum-germanium phosphate based (LAGP) compound, and a lithium-lanthanum-zirconium-titanium oxide-based (LLZTO) compound.

According to certain embodiments, the ceramic compound is optionally in the form of particles having an average diameter of 100 nm to 1000 nm.

According to certain embodiments, the ceramic compound is optionally included in an amount of 10 parts by weight to 100 parts by weight based on 100 parts by weight of the polymer mixture.

According to certain embodiments, the present disclosure includes a battery having the electrolyte described herein.

According to further additional aspects, the present disclosure provides a method for preparing an electrolyte, the method comprising: (S1) preparing a mixture comprising a polymer mixture including a polyethylene(PEO)-based copolymer containing crosslinkable functional groups and a non-crosslinkable PEO-based copolymer, and a ceramic compound; (S2) performing a crosslinking reaction of the PEO-based copolymer containing crosslinkable functional groups included in the mixture such that at least some of the crosslinkable functional groups of the PEO-based copolymer form crosslinks with each other; and (S3) vapor-depositing a polar compound onto the result product formed in (S2) including the crosslinked PEO-based copolymer such that the polar compound is contained in the polymer mixture.

The electrolyte according to one embodiment of the present disclosure is capable of providing an improved ionic conductivity by enhancement of the mobility of the polymer chain and uniform distribution of ceramic particles in the electrolyte while maintaining the original structural characteristics of the polymer without deformation or destruction of the polymer chain.

In addition, the electrolyte can improve the ionic conductivity and mechanical properties of the polymer solid electrolyte by containing a very small amount of a polar compound in gaseous state or liquid state.

In particular, when a polar compound is incorporated into the electrolyte by vapor deposition, it can prevent gelation and delay the relaxation time of the internal polymer chain, thereby improving the mobility of the polymer chain and improving ionic conductivity without degradation of properties.

In addition, according to certain embodiments, the electrolyte includes a crosslinkable PEO-based copolymer and a non-crosslinkable PEO-based copolymer, thereby optimizing the dispersion of the ceramic particles and exhibiting improved ion conductivity, even at a low temperature.

Therefore, the electrolyte according to embodiments of the present disclosure may significantly contribute to providing a solid-state battery having excellent electrochemical characteristics and operating characteristics, even at a low temperature.

According to certain aspects, there is provided an electrolyte including: a polymer in the form of a network structure formed of a polyethylene oxide (PEO)-based copolymer containing crosslinkable functional groups and a crosslinking agent; a ceramic compound; and a polar compound, wherein at least a portion of the crosslinkable functional groups form crosslinks with the crosslinking agent, wherein the polar compound is contained in the network structure, and wherein the crosslinking agent is included at a weight ratio of the crosslinking agent to the polyethylene oxide-based copolymer expressed as:

$${f}_{XL} = \frac{{W}_{XL}}{{W}_{P}} ,$$

wherein W_{XL} is the weight of the crosslinking agent, W_{P} is the weight of the polyethylene oxide-based copolymer, and f_{XL} is 0.07 to 0.19.

According to certain embodiments, the polar compound is optionally dispersed between polymer chains forming the network structure, or is optionally adsorbed or bound to the surface or interior of the polymer chains.

According to certain embodiments, the polar compound is optionally in a gaseous state.

According to certain embodiments, the crosslinking agent optionally includes a multifunctional compound having a plurality of curable functional groups selected from the group consisting of a (meth)acrylic functional group, an alkoxy functional group, a peroxide functional group, a vinyl functional group, a hydroxyl group, an epoxy functional group and an allyl group.

According to certain embodiments, the crosslinkable functional group is optionally connected to a main chain of the polyethylene oxide-based copolymer via a direct bond or a linker having a 1 to 10 carbon number, and wherein the crosslinkable functional group is optionally selected from the group consisting of: a hydroxyl group, a carboxyl group, an isocyanate group, a nitro group, a cyano group, an amine group, an amide group, an epoxy group and an allyl group.

According to certain embodiments, the linker is optionally an alkylene linker or an alkylene oxide linker.

According to certain embodiments, the electrolyte optionally has an ionic conductivity of 0.95 mS/cm or more at 25° C.

According to certain embodiments, the electrolyte optionally further includes a lithium salt.

According to certain embodiments, the lithium salt is optionally included in an amount of 25 to 45 parts by weight, based on 100 parts by weight of the polyethylene oxide-based copolymer containing the crosslinkable functional group.

According to certain embodiments, the polyethylene oxide-based copolymer is optionally a copolymer having repeating units of the following formulas 1 to 3:

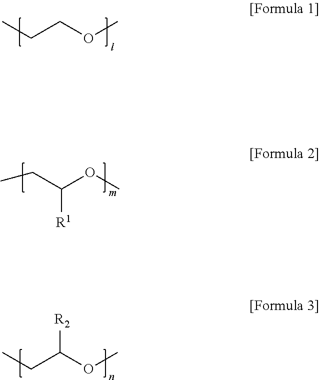

wherein, in the above formulas 1 to 3, R₁ represents —CH₂—O—(CH₂—CH₂—O)ₖ—R₃, k is 0 to 20, and R₃ represents an alkyl group having 1 to 5 carbon atoms, R₂ is a group in which at least one crosslinkable functional group selected from the group consisting of: a hydroxyl group, a carboxyl group, an isocyanate group, a nitro group, a cyano group, an amine group, and an amide group, an epoxy group and an allyl group is bonded to a main chain of the polyethylene oxide-based copolymer via a direct bond or a linker having a 1 to 10 carbon number, l, m, and n are the number of repetitions of the repeating unit, where 1 and n are each independently an integer from 1 to 100,000, and m is an integer from 0 to 100,000.

According to certain embodiments, the linker is optionally an alkylene linker or an alkylene oxide linker.

According to certain embodiments, the content of the polar compound is optionally 0.1% by weight or more and less than 10% by weight, based on the total weight of the electrolyte.

According to certain embodiments, the polar compound optionally includes at least one selected from the group consisting of carbonate-based compounds and sulfonyl-based compounds.

According to certain embodiments, the polar compound optionally includes one or more selected from the group consisting of: ethyl methyl carbonate (EMC), dimethyl carbonate (DMC), diethyl carbonate (DEC), ethylene carbonate (EC), propylene carbonate (PC), vinylene carbonate (VC), and sulfolane.

According to certain embodiments, the ceramic compound optionally includes an oxide-based electrolyte of lithium metal oxide or lithium metal phosphate.

According to certain embodiments, the ceramic compound optionally includes at least one type of oxide-based electrolyte selected from the group consisting of: a lithium-lanthanum-zirconium oxide (LLZO) compound, lithium-silicon-titanium-phosphate based (LSTP) compounds, lithium-lanthanum-titanium oxide based (LLTO) compounds, lithium-aluminum-titanium phosphate based (LATP) compounds, lithium-aluminum-germanium phosphate based (LAGP) compounds and lithium-lanthanum-zirconium-titanium oxide-based (LLZTO) compounds.

According to certain embodiments, the ceramic compound is optionally in the form of particles having a diameter of 100 nm to 1000 nm.

According to certain embodiments, the ceramic compound is optionally included in an amount of 10 parts by weight to 100 parts by weight, based on 100 parts by weight of the polyethylene oxide-based copolymer.

According to certain embodiments, the polyethylene oxide-based copolymer optionally has a weight average molecular weight (Mw) of 100,000 g/mol to 4,000,000 g/mol.

According to certain embodiments, the present disclosure optionally includes a battery having the electrolyte described herein.

According to certain embodiments, the present disclosure provides a method for preparing an electrolyte, the method comprising the steps of: (S1) preparing a mixture comprising a polyethylene oxide-based copolymer containing a crosslinkable functional group, a crosslinking agent, and a ceramic compound, wherein the mixture comprises a weight ratio of crosslinking agent to polyethylene oxide-based copolymer expressed as:

$${f}_{XL} = \frac{{W}_{XL}}{{W}_{P}} ,$$

wherein W_{XL} is the weight of the crosslinking agent, W_{P} is the weight of the polyethylene oxide-based copolymer, and f_{XL} is 0.07 to 0.19; (S2) polymerizing the mixture, wherein the polymerization comprises at least a portion of the crosslinkable functional groups forming crosslinks with the crosslinking agent, and the resulting polymer is in the form of a network structure; (S3) vapor-depositing a polar compound onto the polymer prepared in steps (S1)-(S2).

According to certain embodiments, the method optionally further includes adding an initiator at (S1) or (S2).

According to certain embodiments of the method, the initiator is optionally chosen from the group consisting of benzoyl peroxide, azobisisobutyronitrile, lauroyl peroxide, cumene hydroperoxide, diisopropylphenyl-hydroperoxide, tert-butyl hydroperoxide, paramethane hydroperoxide, and 2,2′-azobis (2-methylpropionitrile).

According to certain embodiments of the method, the initiator that is optionally added in an amount of 0.5 to 2.0 parts by weight, based on 100 parts by weight of the polyethylene oxide-based copolymer.

According to certain embodiments of the method, the polar compound is optionally dispersed between polymer chains forming the network structure, or is adsorbed or bound to the surface or interior of the polymer chains.

According to certain embodiments of the method, the crosslinking agent optionally includes a plurality of crosslinkable functional groups selected from the group consisting of a (meth)acrylic functional group, an alkoxy functional group, a peroxide functional group, a vinyl functional group, a hydroxyl group, an epoxy functional group and an allyl group.

According to certain embodiments of the method, a crosslinkable functional group is optionally connected to a main chain of the polyethylene oxide-based copolymer with a direct bond or a linker having 1 to 10 carbon number, and wherein the crosslinkable functional group is optionally selected from the group consisting of: a hydroxyl group, a carboxyl group, an isocyanate group, a nitro group, a cyano group, an amine group, an amide group, an epoxy group and an allyl group.

According to certain embodiments of the method, the linker is optionally an alkylene linker or an alkylene oxide linker.

According to certain embodiments of the method, the electrolyte formed according to (S1)-(S3) optionally has an ionic conductivity of 0.95 mS/cm or more at 25° C.

According to certain embodiments of the method, the method optionally further includes adding a lithium salt in (S1) or before (S1).

According to certain embodiments of the method, the lithium salt is optionally included in an amount of 25 to 45 parts by weight, based on 100 parts by weight of the polyethylene oxide-based copolymer.

According to certain embodiments of the method, the polyethylene oxide-based copolymer is optionally a copolymer comprising repeating units of the following Formulas 1 to 3:

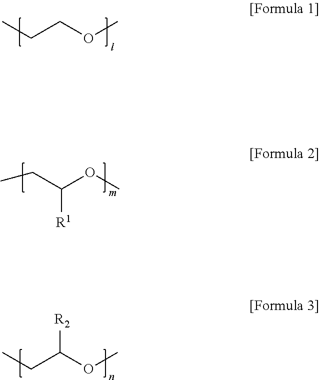

wherein, in the above formulas 1 to 3, R₁ represents —CH₂—O—(CH₂—CH₂—O)ₖ—R₃, k is 0 to 20, and R₃ represents an alkyl group having 1 to 5 carbon atoms, R₂ is a group in which at least one crosslinkable functional group selected from the group consisting of: a hydroxyl group, a carboxyl group, an isocyanate group, a nitro group, a cyano group, an amine group, and an amide group, an epoxy group and an allyl group is bonded to the polymer chain via direct bond or a linker having 1 to 10 carbon number, l, m, and n are the number of repetitions of the repeating unit, where 1 and n are each independently an integer from 1 to 100,000, and m is an integer from 0 to 100,000.

According to certain embodiments of the method, the linker is optionally an alkylene linker or an alkylene oxide linker.

According to certain embodiments of the method, the polar compound is optionally added in an amount such that the electrolyte has 0.1% by weight or more and less than 10% by weight of the polar compound, based on the total weight of the electrolyte.

According to certain embodiments of the method, the polar compound optionally includes at least one selected from the group consisting of carbonate-based compounds and sulfonyl-based compounds.

According to certain embodiments of the method, the polar compound optionally includes one or more selected from the group consisting of: ethyl methyl carbonate (EMC), dimethyl carbonate (DMC), diethyl carbonate (DEC), ethylene carbonate (EC), propylene carbonate (PC), vinylene carbonate (VC), and sulfolane.

According to certain embodiments of the method, the ceramic compound optionally includes an oxide-based electrolyte of lithium metal oxide or lithium metal phosphate.

According to certain embodiments of the method, the ceramic compound optionally includes at least one type of oxide-based electrolyte selected from the group consisting of: a lithium-lanthanum-zirconium oxide (LLZO) compound, lithium-silicon-titanium phosphate based (LSTP) compounds, lithium-lanthanum-titanium oxide based (LLTO) compounds, lithium-aluminum-titanium phosphate based (LATP) compounds, lithium-aluminum-germanium phosphate based (LAGP) compounds and lithium-lanthanum-zirconium-titanium oxide-based (LLZTO) compounds.

According to certain embodiments of the method, the ceramic compound is optionally in the form of particles having a diameter of 100 nm to 1000 nm.

According to certain embodiments of the method, the ceramic compound is optionally included in the mixture in an amount of 10 parts by weight to 100 parts by weight, based on 100 parts by weight of the polyethylene oxide-based copolymer.

According to certain embodiments of the method, the polyethylene oxide-based copolymer optionally has a weight average molecular weight (Mw) of 100,000 g/mol to 4,000,000 g/mol.

The electrolyte according to one embodiment of the disclosure maintains the original structural characteristics of the polymer without deformation or destruction of the polymer chain, improves the mobility of the polymer chain and uniformly distributes ceramic particles in the electrolyte, thereby forming a composite electrolyte. The ionic conductivity of solid electrolyte can be thus improved.

In addition, the electrolyte can improve the ionic conductivity and mechanical properties of the polymer solid electrolyte by containing a very small amount of a polar compound in the gaseous state.

In particular, when a polar compound is incorporated into the electrolyte by vapor deposition, it may prevent gelation and delays the relaxation time of the internal polymer chain, thereby improving the mobility of the polymer chain, thereby improving ionic conductivity without degradation of properties.

Furthermore, according to certain aspects, the electrolyte optimizes the crosslink formation rate by the crosslinking agent, and the effect of improving ion conductivity by vapor deposition can be maximized, thereby improving mechanical properties.

According to certain aspects, an electrode assembly is provided including: a positive electrode; a negative electrode; and a electrolyte layer between the positive electrode and the negative electrode, wherein the electrolyte layer comprises any of the electrolyte described herein, and wherein the positive electrode comprises a positive electrode active material and a binder comprising the PEO-based copolymer having the crosslinkable functional groups.

According to certain aspects, an electrode assembly is provided including: a positive electrode; a negative electrode; and a electrolyte layer between the positive electrode and the negative electrode, wherein the electrolyte layer comprises: a polymer in the form of a network including a polyethylene oxide-based copolymer with crosslinkable functional groups, at least some of which form crosslinks; a ceramic compound; and a polar compound, wherein the polar compound is contained in the three-dimensional network, and wherein the positive electrode comprises a positive electrode active material and a binder comprising the polyethylene oxide-based copolymer having the crosslinkable functional groups.

According to certain embodiments, the polar compound is optionally in a gaseous state and dispersed between crosslinked polymer chains, or is adsorbed or bound to the surface or interior of the polymer chains.

According to certain embodiments, at least some of the crosslinkable functional groups optionally form cross links with each other through a crosslinking agent.

According to certain embodiments, the crosslinkable functional groups are optionally connected to a main chain of the polyethylene oxide-based copolymer via a direct bond or a linker having a 1 to 10 carbon number, and wherein the crosslinked functional groups are optionally selected from the group consisting of: a hydroxyl group, a carboxyl group, an isocyanate group, a nitro group, a cyano group, an amine group, an amide group, an epoxy group and an allyl group.

According to certain embodiments, the linker is optionally an alkylene linker or an alkylene oxide linker.

According to certain embodiments, the electrolyte optionally has an ionic conductivity of 0.95 mS/cm or more at 25° C.

According to certain embodiments, at least one of the electrolyte layer or the positive electrode optionally further includes a lithium salt.

According to certain embodiments, the lithium salt is optionally included in an amount of 25 to 45 parts by weight, based on 100 parts by weight of the polyethylene oxide-based copolymer containing the crosslinkable functional group.

According to certain embodiments, the polyethylene oxide-based copolymer is optionally a copolymer comprising repeating units of the following formulas 1 to 3:

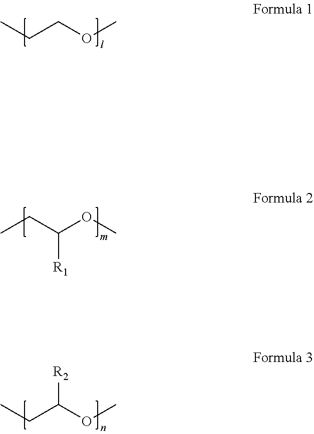

wherein in the above formulas 1 to 3, R₁ represents —CH₂—O—(CH₂—CH₂—O)ₖ—R₃, k is 0 to 20, and R 3 represents an alkyl group having 1 to 5 carbon atoms, R₂ is a group in which at least one cross linkable functional group selected from the group consisting of hydroxyl group, a carboxyl group, an isocyanate group, a nitro group, a cyano group, an amine group, and an amide group, an epoxy group and an allyl group is bonded to a main polymer chain of the polyethylene oxide-based copolymer via a direct bond or a linker having a 1 to 10 carbon number, and l, m, and n are the number of repetitions of the repeating unit, where 1 and n are each independently an integer from 1 to 1,000, and m is an integer from 0 to 1,000.

According to certain embodiments, the linker is optionally an alkylene linker or an alkylene oxide linker.

According to certain embodiments, the polyethylene oxide-based copolymer is optionally a copolymer comprising repeating units of Formula 4:

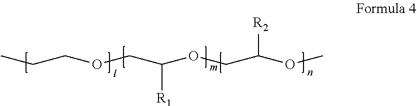

wherein R₁ and R₂ are the same or different from each other, and each is a group having at least one cross linkable functional group selected from the group consisting of: a hydroxyl group, a carboxyl group, an isocyanate group, a nitro group, a cyano group, an amine group, and an amide group, an epoxy group and an allyl group, and l, m and n are each independently an integer from 1 to 1000.

According to certain embodiments, R₁ and R₂ are optionally different from each other.

According to certain embodiments, R₁ and R₂ are optionally different from each other, and one of R₁ and R₂ optionally includes a crosslinkable functional group, and the other of R₁ and R₂ optionally includes an oligomer acting as a plasticizer.

According to certain embodiments, the copolymer has a weight average molecular weight (Mw) of 100,000 g/mol to 2,000,000 g/mol.

According to certain embodiments, the content of the polar compound is optionally 0.1% by weight or more and less than 10% by weight, based on the total weight of the solid electrolyte layer.

According to certain embodiments, the polar compound optionally includes at least one selected from the group consisting of carbonate-based compounds and sulfonyl-based compounds.

According to certain embodiments, the polar compound optionally comprises at least one selected from the group consisting of ethyl methyl carbonate (EMC), dimethyl carbonate (DMC), diethyl carbonate (DEC), ethylene carbonate (EC), propylene carbonate (PC), vinylene carbonate (VC) and sulfolane.

According to certain embodiments, the ceramic compound comprises an oxide-based solid electrolyte of lithium metal oxide or lithium metal phosphate.

According to certain embodiments, the ceramic compound is optionally chosen from the group consisting of lithium-lanthanum-zirconium oxide (LLZO), lithium-silicon-titanium phosphate (LSTP), lithium-lanthanum-titanium oxide (LLTO), lithium-aluminum-titanium phosphate (LATP), lithium-aluminum-germanium phosphate (LAGP), and lithium-lanthanum-zirconium-titanium oxide (LLZTO).

According to certain embodiments, the ceramic compound is optionally in the form of particles having a diameter of 100 nm to 1000 nm.

According to certain embodiments, the ceramic compound is optionally included in an amount of 10 parts by weight to 100 parts by weight, based on 100 parts by weight of the polyethylene oxide-based copolymer.

According to certain embodiments, the electrolyte layer optionally has an activation energy deviation (ΔEₐ) by temperature defined by Equation 1 below of 0.03 eV or less: Equation 1 ΔEₐ=Eₐ^{LT}−Eₐ^{HT}, wherein in Equation 1, Eₐ^{LT} is the activation energy of the electrolyte layer at −40° C. to 10° C., Eₐ^{HT} is the activation energy of the electrolyte layer from 10° C. to 80° C., ΔEₐ represents the activation energy deviation by temperature, which is defined as the difference between the two activation energies.

According to certain embodiments, the electrolyte layer optionally has an activation energy deviation (ΔEₐ) by temperature defined by Equation 1 of 0.02 eV or less.

According to certain embodiments, the positive electrode optionally satisfies the thickness strain defined by Equation 2 below when rolled on both sides using a roll:

$$\frac{d}{{d}_{0}} = {C ( \frac{{δ}_{0}}{δ} )}^{- n} \qquad Equation 2$$

wherein in Equation 2 above, δ₀ and d₀ indicates the initial roll gap and initial thickness of the positive electrode before rolling, δ and d represents the roll gap and the thickness of the positive electrode during rolling, C is a constant determined by regression analysis.

According to certain embodiments, the negative electrode optionally comprises a metal layer.

According to certain embodiments, a battery is provided that optionally comprises the electrode assembly as described herein.

According to certain embodiments, an electrolyte formed according to the principles of the present disclosure includes a predetermined composite solid electrolyte layer manufactured by vapor deposition of a polar compound. This solid electrolyte layer maintains the original structural characteristics of the polymer without deformation or destruction of the polymer chain, while improving the mobility of the polymer chain and uniformly distributing ceramic particles in the electrolyte, and thus exhibits improved ionic conductivity.

In addition, according to certain aspects, the electrolyte can improve the ionic conductivity and mechanical properties of the polymer electrolyte by including a very small amount of a polar compound in the gaseous state.

According to further aspects, an electrode assembly which includes the inventive electrolyte layer as well as an anode comprising the same polymer electrolyte material as a binder, exhibits excellent charge/discharge characteristics at room temperature and at high temperature, high ionic conductivity and excellent mechanical properties.

### BRIEF DESCRIPTION OF THE DRAWING

These and other features of this of this disclosure now be described with reference to the drawing which is intended to illustrate and not to limit the invention.

FIG. 1 is a plot of the ionic conductivity values for Examples 1-3 and Comparative Examples 1-9 vs. the weight ratio of the non-crosslinkable PEO-based copolymer based on a total weight of the polymer mixture.

FIG. 2 is a plot of the ratio of the weight of the crosslinking agent to the weight of the polyethylene oxide-based copolymer versus the ionic conductivity values for Examples 4-6 and Comparative Examples 10-18.

FIG. 3 is schematic illustration of a vapor dispersion of a polar compound within a polymer network.

FIG. 4 is a schematic illustration of a liquid dispersion of a polar compound within any polymer network.

FIG. 5 is a schematic illustration of a rolling operation used for forming an electrode assembly according to the principles of the present disclosure.

FIG. 6 is a plot of the ratio of the positive electrode layer thickness during rolling to the positive electrode layer thickness before rolling versus the ratio of the roll gap during rolling to the roll gap before rolling of Example 7 and Comparative Example 19. This is a graph showing the evaluation of the degree of thickness strain of the positive electrode layer.

FIG. 7 is a graph showing the results of charge/discharge tests of the all-solid-state battery of Comparative Example 19 at room temperature and high temperature (60° C.).

FIG. 8 is a plot log a (ionic conductivity) versus temperature of the electrolyte layer included in Example 7 and Comparative Example 19.

FIG. 9 is a graph showing the results of a room temperature charge/discharge test of the all-solid-state battery of Example 7.

### DETAILED DESCRIPTION

Further aspects, features and advantages of aspects of the invention will become apparent from the detailed description which follows.

As used herein, the singular forms “a”, “an” and “the” are intended to include the plural forms as well, unless the context clearly indicates otherwise. Additionally, the use of “or” is intended to include “and/or”, unless the context clearly indicates otherwise.

All of the numerical values referenced herein should be interpreted as also being modified by the term “about.” As used herein, “about” is a term of approximation and is intended to include minor variations in the literally stated amounts, as would be understood by those skilled in the art. Such variations include, for example, standard deviations associated with techniques commonly used to measure the amounts of the constituent elements or components of a composition or composite material, or other properties and characteristics. All of the values characterized by the above described modifier “about,” are also intended to include the exact numerical values disclosed herein. Moreover, all ranges include the upper and lower limits.

Any compositions described herein are intended to encompass compositions which consist of, consist essentially of, as well as comprise, the various constituents identified herein, unless explicitly indicated to the contrary.

As used herein, the recitation of a numerical range for a variable is intended to convey that the variable can be equal to any value(s) within that range, as well as any and all sub-ranges encompassed by the broader range. Thus, the variable can be equal to any integer value or values within the numerical range, including the endpoints of the range. As an example, a variable which is described as having values between 0 and 10, can be 0, 4, 2-6, 2.75, 3.19-4.47, etc.

In the specification and claims, the singular forms include plural referents unless the context clearly dictates otherwise. As used herein, unless specifically indicated otherwise, the word “or” is used in the inclusive sense of “and/or” and not the exclusive sense of “either/or.”

Technical and scientific terms used herein have the meaning commonly understood by one of skill in the art to which the present description pertains, unless otherwise defined. Reference is made herein to various methodologies and materials known to those of skill in the art.

Unless a specific methodology provided, the various properties and characteristics disclosed herein are measured according to conventional techniques familiar to those skilled in the art.

As used herein, the term “bond” as used with respect to the polar compound and a polymer means that the polar compound is connected to the polymer. For example, with respect to the form of being “bound” to the chain of a polyethylene oxide-based copolymer, “bonding” can include a case where a polar compound molecule, such as a polar compound provided in the gaseous state, becomes fixed to the polymer chain by vapor deposition. It broadly refers to a maintained form. In other words, the term “bond” is not limited to a specific type of physical bond, chemical bond, etc., but may include being fixed by various types of connections including a physical bond, a chemical bond, etc., or simply by being attached and fixed via adsorption, such as may occur in vapor deposition. The term “bond” as used with respect to the polar compound and polymer can also mean that the polar compound is included in a polymer network structure formed by crosslinking of the polymer, such as for example by being located adjacent to and/or fixed to the crosslinked polymer.

As used herein, and unless expressly indicated to the contrary, the term “solid” should not be construed as excluding the presence of a gaseous or liquid substance incorporated within, or otherwise added to, a solid polymer electrolyte material.

As used herein, and unless expressly indicated to the contrary, the term “network structure” should be construed as encompassing two-dimensional as well as three-dimensional network structures. Further, as used herein, the term “network structure” includes a structure having a three-dimensional frame and an internal space formed by the frame, wherein the frame is a crosslink formed by the crosslinkable functional groups. For example, it may include a polymer chain including crosslinking between functional groups and/or crosslinking between crosslinkable functional groups and a crosslinking agent. The network structure can also be referred to as a crosslinked structure.

As used herein, and unless expressly indicated to the contrary, the term “non-crosslinkable PEO-based copolymer” should be construed as PEO-based copolymers which do not form crosslinks with the PEO-based copolymer containing crosslinkable functional groups.

In the present disclosure, the presence or inclusion of a polar compound (e.g. a polar solvent) in an electrolyte (e.g. composite solid electrolyte) in a “gaseous state” indicates that the polar compound is deposited in a vapor state, unlike the case where the polar solvent or the electrolyte containing the same is injected in a liquid state, and the polar compound exists in a state distinct from the liquid injected electrolyte immediately after preparing the composite solid electrolyte or during the charging and discharging process of an all-solid-state secondary battery containing the same. However, depending on the storage or operating conditions of the composite solid electrolyte and/or secondary battery, the vapor-deposited polar compound may have a locally or temporarily liquefied state. Even in such a case, the vapor-deposited polar compound exhibits a higher mobility than the polar solvent injected in a liquid state, and exhibits a state different from the polar solvent in a liquid state, and so can also be considered to exist or be included in the “gaseous state” mentioned above.

Conventionally, in order to improve the ionic conductivity of the solid electrolyte, a composite solid electrolyte was prepared in which ceramic compounds such as oxides were dispersed in a polymer matrix. Such a composite solid electrolyte may exhibit a problem in reducing the ionic conductivity when the oxide ceramic particles in the polymer matrix are unevenly distributed or when a highly crystalline polymer such as polyethylene oxide is used as the polymer.

In addition, conventionally, a solid electrolyte was immersed or supported in a liquid electrolyte or a solvent in a liquid state, or the liquid electrolyte or solvent was directly injected into the solid electrolyte in a liquid state in order to improve the ionic conductivity of the solid electrolyte. In this way, when a liquid electrolyte or solvent is directly added to a solid electrolyte, the ionic conductivity of the solid electrolyte is improved. This was due to the effect of increasing the ionic conductivity of the solid electrolyte based on the high ionic conductivity of the liquid itself. However, the degree of improvement was insufficient, requiring injection of a significant amount of liquid electrolyte. In other words, since the conduction of lithium ions is achieved by the liquid electrolyte added to the solid electrolyte, rather than improving the physical properties of the solid electrolyte itself. In addition, when a liquid electrolyte or solvent is directly added or injected into a solid electrolyte in a liquid state, the polymer chain may be damaged or bonds within the polymer may be broken due to undesired side reactions between the polymer and the liquid phase, causing damage to the solid electrolyte. Accordingly, the structure could collapse, or the ionic conductivity could decrease due to this damage.

Further, when a solvent or a liquid electrolyte is directly injected into the solid electrolyte, liquid molecules rapidly diffuse within the solid electrolyte to cause a fast relaxation of polymer chains and promote gelation on the surface, such that mechanical properties may decrease and problems such as liquid leakage may not be resolved.

Accordingly, aspects of the present disclosure include deposition of a polar compound in a gaseous state derived from a polar compound to an electrolyte, such as a composite solid electrolyte, containing a crosslinked polymer of a polyethylene oxide (PEO)-based copolymer modified with a crosslinkable functional group and a ceramic compound. Aspects of the present disclosure optionally further include optimization of a crosslinking reaction and network structure formation in the composite solid electrolyte by mixing a non-crosslinkable PEO-based copolymer with the PEO-based copolymer containing crosslinkable functional groups. According to certain aspects, electrolytes (e.g. composite solid electrolytes) of the present disclosure may optionally include a polymer containing a PEO-based copolymer containing a crosslinkable functional group, a ceramic compound, and a polar compound, wherein at least some of the crosslinkable functional groups form crosslinks with each other so that the polymer forms a network structure, and the polar compound is contained in the network structure in a gaseous state. Alternatively, the polar compound may be a structure bound to the polymer chain.

According to certain aspects of the present disclosure, the electrolyte (e.g. composite solid electrolyte) may optionally include a polymer mixture including a polyethylene(PEO)-based copolymer containing crosslinkable functional groups and a non-crosslinkable PEO-based copolymer, a ceramic compound, and a polar compound, wherein at least some of the crosslinkable functional groups form crosslinks with each other such that the polymer forms a network structure, and the polar compound is contained in the network structure in a gaseous state. Alternatively, the polar compound may be bound to the polymer chain.

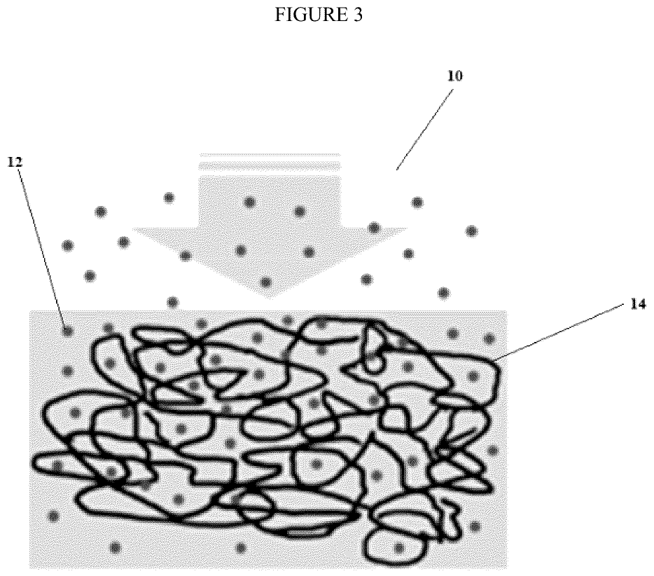

These composite solid electrolytes convert polar compounds derived from trace amounts of polar compounds into gases. It was confirmed that improved ionic conductivity of solid electrolytes formed according to aspects of the present disclosure was observed. Without being bound to any specific theory, and with reference to FIG. 3, it is believed that the gaseous deposition 10 of the polar compounds in a gaseous state 12 into the polymer network 14 results in a uniform dispersion of the polar compound therein and affects the physical properties such as crystallinity of the PEO-based copolymer, and increasing the chain mobility of the polymer chain. This increased mobility appears to improve the conductivity of lithium ions contained in the composite solid electrolyte and exhibit superior ionic conductivity of the electrolytes of certain of the Examples compared to the electrolytes of certain of the Comparative Examples prepared without the gaseous deposition of the polar compounds in a gaseous state.

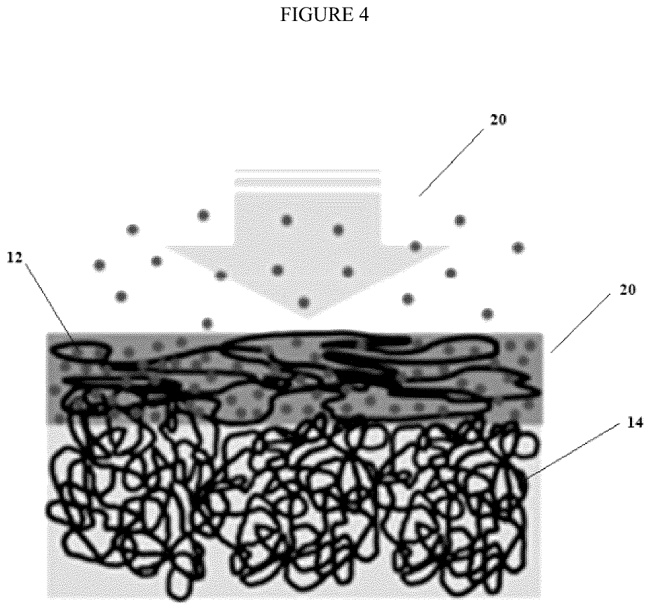

By contrast, with reference to FIG. 4, the liquid deposition 20 of the polar compounds 12 in a liquid state into the polymer network 14 results in the liquid molecules rapidly diffusing into the solid electrolyte, causing rapid relaxation of the polymer chain, promoting gelation on the surface 22 and thereby deteriorating the mechanical properties. Deterioration may occur, problems such as leakage of liquid electrolyte may not be completely solved.

Furthermore, the solid electrolyte (e.g. composite solid electrolyte) may exhibit superior ionic conductivity due to the ceramic compound being uniformly dispersed within the network structure.

According to further aspects of the present disclosure, a PEO-based copolymer containing crosslinkable functional groups and a non-crosslinkable PEO-based copolymer are included in the composite solid electrolyte, and a weight ratio thereof is optionally optimized. For example, the composite solid electrolyte may have a weight ratio of the non-crosslinkable PEO-based copolymer to a total weight of the PEO-based copolymer containing crosslinkable functional groups and the non-crosslinkable PEO-based copolymer of more than 0 and 0.55 or less, 0.05 to 0.53, or 0.3 to 0.5.

Accordingly, crosslinking reaction in the composite solid electrolyte and the network structure can be optimized by optimization of the polymer weight ratio. As a result, improvement in ionic conductivity of the composite solid electrolyte with a vapor deposited polar compound can be maximized, and improvement in mechanical properties can also be exhibited. As the ratio of each polymer is optimized, a crosslinking bond and a network structure in the composite solid electrolyte may be optimized. As a result, the degree of dispersion of the ceramic compound and the mobility of lithium ions may be maximized. Accordingly, the composite solid electrolyte may exhibit excellent ion conductivity of, for example, 0.15 mS/cm or more at a temperature of −30° C. or higher.

According to further aspects of the present disclosure, a weight ratio of a crosslinking agent to a polyethylene oxide-based copolymer used to form a composite solid electrolyte is optimized. Accordingly, the degree of formation of the network structure can be optimized. As a result, improvement in ionic conductivity of the composite solid electrolyte with a vapor deposited polar compound can be maximized, and improvement in mechanical properties can also be exhibited.

In particular, as the crosslinking bond and the network structure in the composite solid electrolyte can be optimized, the degree of dispersion of the ceramic compound and the mobility of lithium ions can be maximized even at a low temperature of, for example, 0° C. or less, or −30° C. to −10° C. As a result, the composite solid electrolyte may exhibit excellent ion conductivity of 0.15 mS/cm or more, 0.20 mS/cm or more, or 0.20 mS/cm to 0.50 mS/cm even at the above described low temperature.

In addition, the composite solid electrolyte may also exhibit excellent ion conductivity of 0.15 mS/cm or more, 0.20 mS/cm or more, or 0.20 mS/cm to 0.50 mS/cm at room temperature of about 25° C.

Thus, according to certain aspects of the present disclosure, the composite solid electrolyte substantially does not contain a liquid polar solvent or electrolyte solution, and exhibits improved ionic conductivity which can greatly contribute to development of solid-state batteries with excellent performance.

Hereinafter, an electrolyte, a solid electrolyte and a composite solid electrolyte formed according to embodiments of the present disclosure will be described in detail. That is, as referred to herein, the electrolyte may include any of a solid electrolyte and/or composite solid electrolyte.

According to certain aspects, a composite solid electrolyte of one embodiment of the present disclosure includes: a polyethylene oxide (PEO)-based copolymer having crosslinkable functional groups; ceramic compounds; and a polar compound. At least some of the crosslinkable functional groups of the copolymer can form crosslinks through a crosslinking agent, so that the copolymer forms a network structure. The polar compound can be contained in the network structure in a gaseous state, or is bound to the polymer chain.

The crosslinking agent may be included so that a ratio of the weight of the crosslinking agent to the PEO-based copolymer is copolymer expressed as:

$${f}_{XL} = \frac{{W}_{XL}}{{W}_{P}} ,$$

wherein W_{XL} is the weight of the crosslinking agent, W_{P} is the weight of the polyethylene oxide-based copolymer, and f_{XL} is 0.07 to 0.19 0.07 to 0.19, or 0.07 to 0.18, or 0.08 to 0.15, or 0.08 to 0.13.

According to certain aspects, a composite solid electrolyte of one embodiment of the present disclosure includes: a polymer mixture including a polyethylene(PEO)-based copolymer containing crosslinkable functional groups and a non-crosslinkable PEO-based copolymer; a ceramic compound; and a polar compound. At least some of the crosslinkable functional groups can form crosslinks with each other, so that the polymer mixture forms a network structure. The polar compound can be contained in the network structure in a gaseous state, or is bound to the polymer chain.

According to one exemplary embodiment, the polar compound in the gaseous state may be dispersed between polymer chains forming the network structure, or may be adsorbed or bound to the surface or interior of the polymer chain.

The composite solid electrolyte optionally substantially contains no liquid solvent or electrolyte solution; it contains a polar compound, in small amounts, contained or bound in a gaseous state by vapor deposition, which will be described later. When observed with the naked eye or an electron microscope, it can be confirmed that liquid components are not observed on the surface of the electrolyte layer. In contrast, if a liquid polar compound is injected to the electrolyte layer the liquid polar compound can be observed. In addition, as confirmed through the Examples described here, the composite solid electrolyte of one embodiment in which the polar compound is vapor-deposited and contained in a gaseous state exhibits significantly high ionic conductivity compared to the case where liquid polar compound or electrolyte solution is injected. Through this comparison of ionic conductivity, it was found that the composite solid electrolyte of the present disclosure, in which the polar compound is vapor-deposited and contained in a gaseous state, exhibit superior ionic conductivity as compared with an electrolyte containing a liquid injected polar compound.

The composite solid electrolyte of the present disclosure, according to certain embodiments, comprises a polymer mixture including a PEO-based copolymer containing crosslinkable functional groups and a non-crosslinkable PEO-based copolymer, where the PEO-based copolymer containing crosslinkable functional groups may be referred to as “crosslinkable” PEO-based copolymer. According to certain embodiments, the composite solid electrolyte of the present disclosure comprises a polymer formed from a copolymer containing at least one crosslinkable functional group. According to certain aspects, the crosslinkable functional group is associated with of a polyethylene oxide (PEO)-based copolymer.

The crosslinkable functional groups may be directly bound to the main chain of the copolymer. Alternatively, the crosslinkable functional groups may be linked thereto via a linker having 1 to 10 carbon number. According to certain embodiments, the linker is an alkylene or alkylene oxide linker.

According to the pre aspects of the present disclosure, the crosslinkable functional group may be selected from the group consisting of a hydroxyl group, a carboxyl group, an isocyanate group, a nitro group, a cyano group, an amine group, an amide group, an epoxy group and an allyl group. According to certain embodiments, the crosslinkable functional group may be selected the group consisting of an epoxy group and an allyl group.

The crosslinkable functional groups may include two or more types of the above mentioned functional groups. The crosslinkable functional groups may be the same or different from each other, and preferably may be different. When the crosslinkable functional groups are different, multiple types of repeating units each containing these functional groups may be included. Also, when multiple types of crosslinkable functional groups are included, control of the mobility and ionic conductivity of the polymer chain may become easier.

The crosslinkable functional group refers to a functional group that can form crosslinks with each other and/or through a crosslinking agent, and may be attached to the main chain of the polymer chain in the form of a side chain.

According to one exemplary embodiment, the composite solid electrolyte comprises a PEO-based copolymer containing crosslinkable functional groups comprises repeating units of the following Formulas 1 to 3:

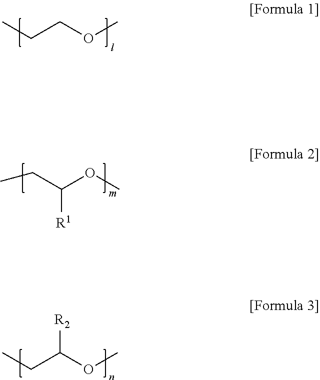

In the above formulas 1 to 3, R₁ represents —CH₂—O—(CH₂—CH₂—O)ₖ—R₃, k is 0 to 20, and R₃ represents an alkyl group having 1 to 5 carbon atoms,

R₂ represents a substituent in which one or more crosslinkable functional groups selected from the group consisting of a hydroxyl group, a carboxyl group, an isocyanate group, a nitro group, a cyano group, an amine group, an amide group, an epoxy group and an allyl group are bonded to a polymer chain via a direct bond or a linker having 1 to 10 carbon atoms.

According to certain aspects, the linker may be an alkylene or alkylene oxide linker.

l, m, and n are the number of repetitions of the repeating unit, where 1 and n are each independently an integer from 1 to 100,000, 50 to 80,000, or 100 to 50,000, and m is an integer from 0 to 100,000, 50 to 80,000, or 100 to 50,000.

When l, m, and n are each too small, it is difficult to form a polymer due to the low molecular weight. When l, m, and n are each too large, the solubility decreases when preparing a polymer solution due to an increase in viscosity, and molding and mixing the composite solid electrolyte during manufacturing may become difficult. In particular, when the number of repeats of the repeating unit containing the crosslinkable functional group among l, m, and n is too large, the degree of crosslinking may be excessively increased and the mobility of the polymer chain may decrease, resulting in a decrease in ionic conductivity.

In this specification, “hydroxy group” refers to —OH group.

In this specification, “carboxyl group” refers to —COOH group.

In this specification, “isocyanate group” refers to a —N═C═O group.

As used herein, “nitro group” refers to —NO₂ group.

In this specification, “cyano group” refers to a —CN group.

As used herein, “amine group” may be selected from the group consisting of a monoalkylamine group; a monoarylamine group; a monoheteroarylamine group; a dialkylamine group; a diarylamine group; a diheteroarylamine group; an alkylarylamine group; an alkylheteroarylamine group; and an arylheteroarylamine group, and the carbon number thereof is not particularly limited, but is preferably 1 to 30. Specific examples of the amine group include a methylamine group, a dimethylamine group, an ethylamine group, a diethylamine group, a phenylamine group, a naphthylamine group, a biphenylamine group, a dibiphenylamine group, an anthracenyl amine group, a 9-methyl-anthracenylamine group, a diphenylamine group, a phenylnaphthylamine group, a ditolylamine group, a phenyltolylamine group, a triphenylamine group, a biphenylnaphthylamine group, a phenylbiphenyl amine group, a biphenylfluorenylamine group, a phenyltriphenylenylamine group, a biphenyltriphenylenylamine group, and the like, but are not limited thereto.

As used herein, “amide group” refers to —C(═O)NR′R″, wherein R′ and R″ may each independently be hydrogen or a C1 to C5 alkyl group, or R′ and R″ together with the N atom to which they are attached may form a heterocycle having C4 to C8 atoms in the ring structure.

As used herein, “amino group” refers to —NH₂.

As used herein, “epoxy group” refers to a group comprised of two carbons and an oxygen forming a ring structure.

As used herein, “allyl group” refers to the —CH₂—CH═CH₂ group.

According to one exemplary embodiment, the PEO-based copolymer containing crosslinkable functional groups is a copolymer having repeating units of the following Formulas 1 to 3:

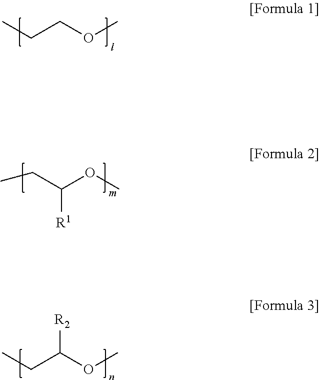

In the above formulas 1 to 3, R₁ represents —CH₂—O—(CH₂—CH₂—O)ₖ—R₃, k is 0 to 20, and R₃ represents an alkyl group having 1 to 5 carbon atoms,

R₂ represents a substituent in which one or more crosslinkable functional groups selected from the group consisting of a hydroxyl group, a carboxyl group, an isocyanate group, a nitro group, a cyano group, an amine group, an amide group, an epoxy group and an allyl group are bonded to a polymer chain via a direct bond or a linker having 1 to 10 carbon atoms,

the linker may be an alkylene or alkylene oxide linker, and

l, m, and n are the number of repetitions of the repeating unit, where 1 and n are each independently an integer from 1 to 100,000, 50 to 80,000, or 100 to 50,000, and m is an integer from 0 to 100,000, 50 to 80,000, or 100 to 50,000.

According to one exemplary embodiment, the non-crosslinkable PEO-based copolymer is a copolymer having repeating units of the following Formulas 1 and 2, the copolymer not containing the repeating unit of Formula 3:

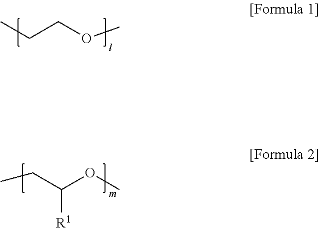

In the above formulas 1 to 2, R₁ represents —CH₂—O—(CH₂—CH₂—O)ₖ—R₃, k is 0 to 20, and R₃ represents an alkyl group having 1 to 5 carbon atoms, and

l and m are the number of repetitions of the repeating unit, where l and m are each independently an integer from 1 to 100,000, 50 to 80,000, or 100 to 50,000.

The weight average molecular weight (Mw) of the “crosslinkable” and “non-crosslinkable” copolymers may be 100,000 g/mol to 4,000,000 g/mol, specifically, 100,000 g/mol or more, 200,000 g/mol or more, or 300,000 g/mol or more, and 3,000,000 g/mol or less, or 2,000,000 g/mol or less. If the weight average molecular weight (Mw) is too small, the mechanical properties of the manufactured composite solid electrolyte may not be adequate. If the weight average molecular weight (Mw) is too large, the solubility may decrease when preparing a polymer solution due to an increase in viscosity and molding or mixing during manufacturing a composite solid electrolyte may become difficult. Additionally, the ionic conductivity of the solid electrolyte may decrease due to increased crystallinity and decreased chain mobility inside the electrolyte.

According to one specific embodiment, the crosslinkable functional group of R₂ can form a network structure formed by crosslinking. By forming a network structure, the mechanical properties of the composite solid electrolyte can be improved. In one embodiment, a composite solid electrolyte with improved ionic conductivity can be provided by including or combining the polar compound in the gaseous state within this network structure.

In addition, the crosslinkable PEO-based copolymer may include two or more repeating units of Formula 3 in which R₂ is a different crosslinkable functional group. One or more types of repeating units of Formula 2 may also be included.

Moreover, when the number of the repeating unit of Formula 3 including the crosslinkable functional group of R₂ is excessively large, degree of crosslinking is excessively increased to decrease mobility of the polymer chains, thereby reducing ion conductivity of the composite solid electrolyte.

Additionally, the crosslinkable and non-crosslinkable PEO-based copolymers may be a random copolymer or a block copolymer.

According to one specific embodiment, the polymer mixture consists of the PEO-based copolymer containing crosslinkable functional groups and the non-crosslinkable PEO-based copolymer.

According to one specific embodiment, the polymer mixture including the crosslinkable and non-crosslinkable PEO-based copolymers may have a weight ratio of the non-crosslinkable PEO-based copolymer to a total weight of the polymer mixture of more than 0 and 0.55 or less, 0.05 to 0.53, or 0.3 to 0.5, and may contain the crosslinkable PEO-based copolymer at the remaining weight ratio. When the weight ratio of the non-crosslinkable PEO-based copolymer is excessively high, the network structure cannot be properly formed, and the vapor deposition of the polar compound may not be processed properly, and thus the mechanical properties and ion conductivity of the composite solid electrolyte may be deteriorated. In addition, when the weight ratio of the non-crosslinkable PEO-based copolymer is excessively low, ion conductivity may be also decreased.

According to one specific embodiment, the PEO-based copolymer containing crosslinkable functional groups and the non-crosslinkable PEO-based copolymer in the polymer mixture may be mixed at a weight ratio of 5:5 to 9:1. Similarly to above, when the weight ratio of the non-crosslinkable PEO-based copolymer is excessively high, the network structure cannot be properly formed, and the vapor deposition of the polar compound may not be processed properly, and thus the mechanical properties and ion conductivity of the composite solid electrolyte may be deteriorated. In addition, when the weight ratio of the non-crosslinkable PEO-based copolymer is excessively low, ion conductivity may be also decreased.

According to one specific embodiment, the polar compound may be contained or bound to the surface or interior of the polymer chain in a gaseous state. Specifically, the polar compound in the gaseous state may be diffused or dispersed between the polymer chains forming a network structure, or may be adsorbed or bound to the surface or interior of the polymer chains. Thus, the polar compound can improve the ionic conductivity of the final manufactured composite solid electrolyte.

Specifically, a polar compound bound to the polymer chain or included between the polymer chains can act as a plasticizer and plasticize the polymer. The plasticized polymer may have an increased amorphous region inside, thereby improving the mobility of the polymer chain. As the mobility of the polymer chain improves, the ion hopping effect inside the polymer increases, and the ionic conductivity of the composite solid electrolyte can be improved.

In addition, the polar compound can act as an intermediate. Since the affinity between lithium ions and polar compounds is stronger than the affinity between lithium ions and the ether oxygen of PEO-based copolymers, the transfer of lithium ions within the polymer to which the polar compounds are adsorbed is more likely. In other words, as the polar compound is introduced into the polymer, the cation solvation effect of lithium ions is increased, so ion mobility is improved, and thus the ionic conductivity of the composite solid electrolyte can be improved.

The polar compound may include one or more types selected from the group consisting of carbonate-based compounds and sulfonyl-based compounds.

Specifically, the polar compounds may include ethyl methyl carbonate (EMC), dimethyl carbonate (DMC), diethyl carbonate (DEC), ethylene carbonate (EC), propylene carbonate (PC), vinylene carbonate (VC), and sulfolane, or a combination thereof.

The composite solid electrolyte may contain the polar compound in an amount of 0.1% by weight or more and less than 10% by weight based on the total weight of the electrolyte. For example, the content of the polar compound may be 0.1 wt % or more, 1 wt % or more, 2 wt % or more, or 5 wt % or less, 6 wt % or less, 7 wt % or less, 8 wt % or less, or 9 wt % or less, or may be less than 10% by weight. When the content of the polar compound is less than 0.1% by weight, it is difficult to cause a change in the chain conformation inside the polymer, so the ionic conductivity of the composite solid electrolyte is not improved. When the content of the polar compound is 10% by weight or more, the content in the polar compound in the composite solid electrolyte is high, so the polymer begins to take on the properties of a semi-solid electrolyte. Additionally, the mechanical strength of the composite solid electrolyte may decrease due to gelation of the polymer.

According to one specific embodiment, the composite solid electrolyte may include crosslinks formed by the crosslinkable functional groups. In addition, the composite solid electrolyte may contain a crosslinking agent, and may include crosslinks formed by the crosslinking agent and the crosslinkable functional groups. For example, at least some of the cross linkable functional groups form crosslinks with each other through the crosslinking agent, thus the above described network structure can be formed.

The crosslinks may be urethane bonds, ester bonds, hydrogen bonds, or bonds formed by radical polymerization of a terminal vinyl group in an allyl group, —CH₂—CH═CH₂, but are not limited thereto.

Further, when the crosslinking agent is added in a preparation process of the composite solid electrolyte, a crosslink between the crosslinking agent and the crosslinkable functional group may be formed. The crosslinking may be a hydrogen bond, a bond formed by Lewis acid-base interaction, an ionic bond, a coordination bond, or a bond formed by radical polymerization.

According to certain embodiments, the crosslinking agent can include a (meth)acrylic functional group, alkoxy functional group, peroxide type functional group, vinyl type functional group, hydroxyl group, or an epoxy-based system. One or more types of crosslinking agent may be utilized. According to certain option embodiments, polyfunctional compounds having a plurality of curable functional groups can be selected from the group consisting of functional groups and allyl groups.

The crosslinking agent is not particularly limited, and can be a multifunctional crosslinking agent that can form a crosslink with the crosslinkable functional group. For example, the crosslinking agent may be one or more multifunctional crosslinking agents selected from the group consisting of trimethylolpropane trimethacrylate, polyethylene glycol diacrylate (poly(ethylene glycol) diacrylate), polyethylene glycol dimethacrylate (poly(ethylene glycol) dimethacrylate), ethylene glycol dimethyl acrylate (ethylene glycol dimethylacrylate) (“EGDMA”), 1,3-diisopropenylbenzene (DIP), 1,4-diacryloyl piperazine (1,4-diacryloyl piperazine), 2-(diethylamino) ethyl methacrylate (2,6-bisacryloylamidopyridine, 2,6-bisacryloylamidopyridine, 3-(acryloxy)-2-hydroxypropyl methacrylate, 3,5-bis(acryloylamido) benzoic acid, 3-aminopropyltriethoxysilane, 3-isocyanatopropyltriethoxysilane, 3-methylacryloxypropyl trimethoxysilane, bis-(1-(tert-butyl peroxy)-1-methylethyl)-benzene, dicumyl peroxide, dimethacrylate, divinylbenzene, ethylene glycol, ethylene glycol maleic rosinate acrylate, glycidilmethacrylate, hydroxy quinoline (hydroxyquinoline), iphenyldiethoxysilane, maleic rosin glycol acrylate (maleic rosin glycol acrylate), methylene bisacrylamide (methylene bisacrylamide), N,N′1,4-phenylenediacrylamine (N,N′-1,4-phenylene diacrylamine), N,O-bisacryloyl phenylalaninol (N,O-bis-acryloyl-phenylalaninol), N,O-bismethacryloyl ethanolamine (N,O-bis-methacryloyl ethanolamine), pentaerythritol triacrylate, phenyltrimethoxy silane, tetramethoxysilane, tetramethylene, tetraethoxysilane, and triallyl isocyanurate.

Further, according to one embodiment, the crosslinking agent may be included in an amount of 1 to 30 parts by weight based on 100 parts by weight of the PEO-based copolymer containing the crosslinkable functional group. When the content of the crosslinking agent is less than 1 part by weight, crosslinking with the crosslinkable functional group may not be sufficiently achieved, and when the content of the crosslinking agent is more than 30 parts by weight, excessive crosslinking may occur and the mobility of the polymer chain may decrease, which leads to a decrease in ionic conductivity.

According to one embodiment, the crosslinking agent may be included in an amount such that a ratio of the weight of the crosslinking agent to the weight of the PEO-based copolymer containing to the crosslinkable functional group is expressed as:

$${f}_{XL} = \frac{{W}_{XL}}{{W}_{P}} ,$$

wherein W_{XL} is the weight of the crosslinking agent, W_{P} is the weight of the polyethylene oxide-based copolymer, and f_{XL} is 0.07 to 0.19, or 0.07 to 0.18, or 0.08 to 0.15, or 0.08 to 0.13. If the weight ratio of the crosslinking agent is too small, the formation of a network structure is not properly achieved, making it difficult to apply the polar compound through vapor deposition. As a result, the ionic conductivity of the solid electrolyte may be greatly reduced. On the other hand, when the weight ratio of the crosslinking agent becomes too large, excessive crosslinking of network structure may result in a decrease in the mobility of the polymer chains, thereby lowering ionic conductivity.

According to one specific embodiment, the composite solid electrolyte may further include lithium salt. The lithium salt is contained in a dissociated ion state in the internal space between polymer chains, thereby improving the ionic conductivity of the composite solid electrolyte. At least a portion of the cations and/or anions dissociated from the lithium salt remain bound to the polymer chain, and can exhibit mobility when charging/discharging a battery containing the composite solid electrolyte.

The lithium salt may be one or more selected from the group consisting of (CF₃SO₂)₂NLi(lithium bis(trifluoromethanesulphonyl)imide, LiTFSI), (FSO₂)₂NLi(lithium bis(fluorosulfonyl)imide, LiFSI), LiNO₃, LiGH, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃, lithium chloroborane, lithium lower aliphatic carboxylate and lithium tetraphenyl borate. According to certain embodiments, the lithium salt may include lithium borate.

Further, the lithium salt may be included in an amount of 25 to 45 parts by weight, based on 100 parts by weight of the PEO-based copolymer containing the crosslinkable functional group. Specifically, it may be included in an amount of 25 parts by weight or more, 30 parts by weight or more, or 35 parts by weight or more, or 40 parts by weight or less, or 45 parts by weight or less. If the content of the lithium salt is less than 25 parts by weight, the ionic conductivity of the composite solid electrolyte may decrease, and if the content of the lithium salt exceeds 45 parts by weight, the mechanical strength may decrease.

The above described composite solid electrolyte may include a ceramic compound. The ceramic compound has a lithium ion transfer ability to improve the conductivity of lithium ions, and preferably contains lithium atoms but does not store lithium, and has the function of transporting lithium ions, and can improve the ionic conductivity of the composite solid electrolyte.

In addition, the ceramic compound may be included in a uniformly dispersed state in the internal space of crosslinked polymer chains, for example, within the network structure. The ceramic compound is added together in the crosslinking process, and can be uniformly dispersed without aggregation in the internal space of the polymer chains formed by crosslinking. Such ceramic compounds can be advantageous in improving the mechanical strength and ionic conductivity of the composite solid electrolyte due to its uniformly dispersed form.

Further, the ceramic compound may be in the form of particles. Due to the morphological characteristics of particles, they can be contained in a more uniformly dispersed state within the composite solid electrolyte. The particles of the ceramic compound may be spherical, and its diameter may be 100 nm to 1000 nm. If the diameter is less than 100 nm, the effect of non-crystallization due to the decrease in crystallinity of the polymer may be slight, and if the diameter is more than 1000 nm, dispersibility may decrease due to an increase of aggregation between particles, which may make it difficult to disperse uniformly.

The ceramic compound may be an oxide-based or phosphate-based compound, for example, an oxide-based ceramic compound in the form of lithium metal oxide or lithium metal phosphate. More specifically, the ceramic compound may be at least one selected from the group consisting of garnet-type lithium-lanthanum-zirconium oxide(LLZO, Li₇La₃Zr₂O₁₂)-based compound, perovskite-type lithium-lanthanum-titanium oxide(LLTO, Li₃xLa_{2/3-x}TiO₃)-based compound, phosphate-based NASICON type lithium-aluminum-titanium phosphate(LATP, Li₁₊ₓAlₓTi₂₋ₓ(PO₄)₃)-based compound, lithium-aluminum-germanium phosphate(LAGP, Li_{1.5}Al_{0.5}Ge_{1.5}(PO₄)₃)-based compound, lithium-silicon-titanium phosphate(LSTP, LiSiO₂TiO₂(PO₄)₃)-based compound, and lithium-lanthanum-zirconium-titanium oxide (LLZTO)-based compound. More preferably, at least one oxide-based solid electrolyte selected from the group consisting of lithium-lanthanum-zirconium oxide(LLZO), lithium-silicon-titanium phosphate(LSTP), lithium-lanthanum-titanium oxide(LLTO), lithium-aluminum-titanium phosphate(LATP), lithium-aluminum-germanium phosphate(LAGP), and lithium-lanthanum-zirconium-titanium oxide(LLZTO) may be used. One or more types of oxide-based ceramic compounds selected from the group can be used.

The oxide-based or phosphate-based ceramic compound generally has an ionic conductivity value of up to 10⁻⁴˜10⁻³ S/cm at room temperature, and has the advantage of being stable in a high voltage region, being stable in air, and thus being easy to synthesize and handle.

Therefore, the above mentioned electrolyte may comprise a composite electrolyte mixed with a ceramic compound to compensate for the drawbacks associated with a polymer-based solid electrolyte.

Further, the ceramic compound does not easily cause combustion or ignition phenomenon even under high temperature conditions of 400° C. or more, and thus has increased high-temperature stability. Therefore, when the composite electrolyte contains a ceramic compound, not only the mechanical strength but also the high-temperature stability and ionic conductivity of the composite electrolyte can be improved.

The ceramic compound may be included in an amount of 10 to 100 parts by weight based on 100 parts by weight of the copolymer. Alternatively, the ceramic compound may be included in 10 to 60 parts by weight based on 100 parts by weight of the copolymer.

When the ceramic compound is included in an amount below the above mentioned range, the effect of lowering the crystallinity of the polymer and making it amorphous due to the ceramic compound may be reduced, so that the effect of increasing the ionic conductivity of the composite solid electrolyte is not significant, and the mechanical properties may also be degraded.

When the ceramic compound is included in an amount that exceeds the above mentioned range, the ceramic compound may not be uniformly dispersed within the polymer, which may cause the ceramic compound particles to clump together and aggregate, resulting in the production of a composite solid electrolyte with reduced ionic conductivity.

The above described composite solid electrolyte can exhibit excellent ionic conductivity. For example, ionic conductivity measured at a temperature of −30° C. or higher may be 0.15 or more, 0.20 mS/cm or more, or 0.30 mS/cm or more.

Moreover, the above described composite solid electrolyte can exhibit excellent ionic conductivity. For example, ionic conductivity measured at room temperature of about 25° C. may be 0.20 mS/cm or more, 0.30 mS/cm or more, or 0.50 mS/cm to 1.50 mS/cm.

According to certain embodiments, the above described composite solid electrolyte can exhibit an ionic conductivity measured at room temperature of about 25° C. of 0.95 mS/cm or more, or more than 1.0 mS/cm. Alternatively, it may exhibit excellent ionic conductivity of 1.0 mS/cm to 3.0 mS/cm.

Furthermore, the above described composite solid electrolyte can exhibit excellent ionic conductivity of 0.15 mS/cm or more, 0.20 mS/cm or more, or 0.20 mS/cm to 0.50 mS/cm even at a low temperature, for example, in the temperature range of −30° C. to −10° C.

This ionic conductivity can be measured using an electrochemical impedance spectrometer at a certain temperature such as the room temperature described above or the low temperature in the range of −30° C. to −10° C. It can be calculated from the measured resistance (Ω) of the composite solid electrolyte according to Equation 1 below:

$${σ}_{i} = \frac{L}{RA} \qquad [ Equation 1 ]$$

In Equation 1, σᵢ is the ionic conductivity of the composite solid electrolyte (S/cm), R is the resistance (Ω) of the composite solid electrolyte measured with the electrochemical impedance spectrometer, and L is the thickness of the composite solid electrolyte (in μm), and A is the area of the composite solid electrolyte (in cm²).

The electrolyte optionally has an activation energy deviation (ΔEₐ) by temperature defined by Equation 2 of 0.03 eV or less:

$$Δ {E}_{a} = {E}_{a}^{LT} - {E}_{a}^{HT} \qquad [ Equation 2 ]$$

In Equation 2, Eₐ^{LT} is the activation energy of the electrolyte layer at −40° C. to 10° C., Eₐ^{HT} is the activation energy of the electrolyte layer from 10° C. to 80° C., ΔEₐ represents the activation energy deviation by temperature, which is defined as the difference between the two activation energies. Alternatively, the activation energy (ΔEₐ) may be 0.005 to 0.025 eV.

At this time, the activation energy deviation can be calculated from the ionic conductivity of the electrolyte measured by absolute temperature. More specifically, based on the measurement result of ionic conductivity (σi) by temperature, log(σi) and 1000/T (T is the relationship between the absolute temperature at which the corresponding ion conductivity was measured), the Arrhenius formula of Eq. 3 below, and the activation energy Ea corresponding to the slope can be derived, from which the Ea^{LT} of the Eq. 1, Ea^{HT} and ΔEₐ can be calculated respectively.

$${σ}_{i} = {σ}_{i , 0} exp [ - \frac{{E}_{a}}{RT} ] \qquad [ Equation 3 ]$$

In the equation, σi,₀ represents the maximum ionic conductivity of the electrolyte layer, σᵢ represents the ionic conductivity of the electrolyte layer measured at absolute temperature T, Eₐ represents the activation energy of the electrolyte layer at absolute temperature T, and R represents the gas constant.

From this low activation energy deviation, it can be seen that the above-described electrolyte exhibits excellent ionic conductivity and electrochemical properties without significant deviations despite temperature variations.

Further, the electrolyte layer optionally has an activation energy deviation (ΔEₐ) by temperature defined by Equation 2 of 0.005 to 0.025 eV.

Hereinafter, exemplary methods of manufacturing the electrolyte of the present disclosure will be described.

According to a first embodiment, the method may comprise: (S1) preparing a mixture comprising a polymer mixture including a polyethylene(PEO)-based copolymer containing crosslinkable functional groups and a non-crosslinkable PEO-based copolymer at the above described weight ratio, and a ceramic compound; (S2) performing a crosslinking reaction of the PEO-based copolymer containing crosslinkable functional groups included in the mixture; and (S3) vapor depositing a polar compound onto the mixture including the crosslinked polymer formed in (S2).

The descriptions of the PEO-based copolymer containing crosslinkable functional groups and the non-crosslinkable PEO-based copolymer are the same as above.

Each step is described in more detail below.

In the step (S1), the PEO-based copolymer containing crosslinkable functional groups, the non-crosslinkable PEO-based copolymer, and the ceramic compound are mixed.

In the step (S2), a crosslinking reaction is performed on the PEO-based copolymer containing crosslinkable functional groups included in the mixture, thereby preparing the polymer forming the above described network structure.

The crosslinking reaction in the step (S2) may be performed in the presence of one or more selected from the group consisting of a crosslinking agent and an initiator.

In addition, a lithium salt may be added in the step (S1) to form the composite solid electrolyte. The lithium salt used in the composite solid electrolyte as described above may be used, and the same amount as described above may also be used.

Further, the ceramic compound used in the composite solid electrolyte as described above may be used, and the same amount as described above may also be used.

The crosslinking reaction may be performed in the process of drying a coating film formed by applying a solution containing the crosslinkable PEO-based copolymer, the non-crosslinkable PEO-based copolymer, and a ceramic compound on a substrate.

Specifically, the mixed solution may be prepared by mixing the crosslinkable PEO-based copolymer, the non-crosslinkable PEO-based copolymer, and the ceramic compound in a solvent, and may be prepared by additionally mixing a crosslinking agent, an initiator, and/or a lithium salt. In addition, a solution containing the crosslinkable PEO-based copolymer, non-crosslinkable PEO-based copolymer, the crosslinking agent, the initiator and/or the lithium salt may be prepared first, and then a mixed solution or suspension may be prepared by adding the ceramic compound.

The solvent is not particularly limited as long as it can be mixed with the crosslinkable and non-crosslinkable PEO-based copolymers, the crosslinking agent, the initiator and/or the lithium salt, and can be easily removed by the drying process. For example, the solvent may be acetonitrile, methanol, ethanol, tetrahydrofuran, water, isopropyl alcohol, dimethyl sulfoxide (DMSO), N-methyl-2-pyrrolidone (NMP), N,N-dimethyl formamide (DMF) or the like. Such a solvent is a solvent that serves as a reaction medium for forming a crosslink, and is distinguished from polar solvents contained in liquid electrolytes, and the like, and is completely removed by drying or the like after crosslinking.

According to a second embodiment, the method generally comprises the steps of: (S1) preparing a mixture comprising a polyethylene oxide-based copolymer containing a crosslinkable functional group, a crosslinking agent, and a ceramic compound, wherein the mixture comprises a weight ratio of crosslinking agent to polyethylene oxide-based copolymer expressed as:

$${f}_{XL} = \frac{{W}_{XL}}{{W}_{P}} ,$$

wherein W_{XL} is the weight of the crosslinking agent, W_{P} is the weight of the polyethylene oxide-based copolymer, and f_{XL} is 0.07 to 0.19; (S2) polymerizing the mixture, wherein the polymerization comprises at least a portion of the crosslinkable functional groups forming crosslinks with the crosslinking agent, and the resulting polymer is in the form of a network structure; (S3) vapor-depositing a polar solvent onto the polymer prepared in steps (S1)-(S2).

In a step (S1)-(S2), a crosslinking reaction is performed on the PEO-based copolymer contained in this mixture in the presence of the ratio of crosslinking agent, both previously described herein. Thus, a polymer forming the above-described network structure can be formed. Optionally, in (S1) the PEO-based copolymer and the previously described ceramic compound are mixed, and then the crosslinking reaction is performed on the mixture. The crosslinking reaction in step (S2) may proceed in the presence of the crosslinking agent and an initiator of the type previously disclosed herein.

The types and amounts of all the constituent components utilized according to these methods of the present disclosure are the same types and amounts described elsewhere herein.

The crosslinking reaction may be performed in the process of forming a coating film by applying a solution or slurry containing the PEO-based copolymer and a ceramic compound, and the other above described constituents, on a substrate and then drying the deposited solution.

Specifically, the mixed solution or slurry may be prepared by mixing the PEO-based copolymer and the ceramic compound in a solvent, and may additionally be prepared by mixing a crosslinking agent, an initiator, and/or a lithium salt. In addition, the above PEO-based copolymer and crosslinking agent, initiator and/or a solution containing a lithium salt may be prepared first, and then a mixed solution or suspension may be prepared by adding a ceramic compound.

The solvent is not particularly limited as long as it is a solvent that can be mixed and dissolved with the PEO-based copolymer, ceramic compound, the crosslinking agent, the initiator and/or the lithium salt, and can be easily removed by a drying process. For example, the solvent may be acetonitrile, methanol, ethanol, tetrahydrofuran, water, isopropyl alcohol, dimethyl sulfoxide (DMSO), N-methyl-2-pyrrolidone (NMP), N,N-dimethyl formamide (DMF) or the like. Such a solvent is a solvent that serves as a reaction medium for forming a crosslinking bond, and is distinguished from polar solvents contained in liquid electrolytes, and the like, and is completely removed by drying or the like after crosslinking.

According to a third embodiment, the method generally comprises the steps of: (S1) preparing a mixture comprising a polyethylene oxide-based copolymer containing a crosslinkable functional group, a crosslinking agent, and a ceramic compound, wherein the mixture optionally comprises a weight ratio of crosslinking agent to polyethylene oxide-based copolymer expressed as:

$${f}_{XL} = \frac{{W}_{XL}}{{W}_{P}} ,$$

wherein W_{XL} is the weight of the crosslinking agent, W_{P} is the weight of the polyethylene oxide-based copolymer, and f_{XL} is 0.07 to 0.19; (S2) polymerizing the mixture, wherein the polymerization comprises at least a portion of the crosslinkable functional groups forming crosslinks with the crosslinking agent, and the resulting polymer is in the form of a network structure; (S3) vapor-depositing a polar solvent onto the polymer prepared in steps (S1)-(S2).

In a step (S1)-(S2), a crosslinking reaction is performed on the PEO-based copolymer contained in this mixture in the presence of the ratio of crosslinking agent, both previously described herein. Thus, a polymer forming the above-described network structure can be formed. Optionally, in (S1) the PEO-based copolymer and the previously described ceramic compound are mixed, and then the crosslinking reaction is performed on the mixture. The crosslinking reaction in step (S2) may proceed in the presence of the crosslinking agent and an initiator of the type previously disclosed herein.

The types and amounts of all the constituent components utilized according to these methods of the present disclosure are the same types and amounts described elsewhere herein.

The crosslinking reaction may be performed in the process of forming a coating film by applying a solution or slurry containing the PEO-based copolymer and a ceramic compound, and the other above described constituents, on a substrate and then drying the deposited solution.

Specifically, the mixed solution or slurry may be prepared by mixing the PEO-based copolymer and the ceramic compound in a solvent, and may additionally be prepared by mixing a crosslinking agent, an initiator, and/or a lithium salt. In addition, the above PEO-based copolymer and crosslinking agent, initiator and/or a solution containing a lithium salt may be prepared first, and then a mixed solution or suspension may be prepared by adding a ceramic compound.

The solvent is not particularly limited as long as it is a solvent that can be mixed and dissolved with the PEO-based copolymer, ceramic compound, the crosslinking agent, the initiator and/or the lithium salt, and can be easily removed by a drying process. For example, the solvent may be acetonitrile, methanol, ethanol, tetrahydrofuran, water, isopropyl alcohol, dimethyl sulfoxide (DMSO), N-methyl-2-pyrrolidone (NMP), N,N-dimethyl formamide (DMF) or the like. Such a solvent is a solvent that serves as a reaction medium for forming a crosslinking bond, and is distinguished from polar solvents contained in liquid electrolytes, and the like, and is completely removed by drying or the like after crosslinking.

The concentration of the polymer solution provided in any of the first through third embodiments above can be appropriately adjusted in consideration of the extent to which the molding process for preparing the polymer solid electrolyte can proceed smoothly. Specifically, the concentration of the polymer solution may mean the concentration (w/w %) of the polymer in the polymer solution. The concentration of the polymer may be the concentration of the PEO-based copolymer. For example, the concentration of the polymer solution may be 5% by weight to 20% by weight, and specifically, it may be 5% by weight or more, 7% by weight or more, or 9% by weight or more, and 13% by weight or less, 17% by weight or less, or 20% by weight or less. If the concentration of the polymer solution is less than 5% by weight, the concentration may be too diluted, and the mechanical strength of the polymer solid electrolyte may decrease, or it may flow down when coated onto a substrate. If the concentration of the polymer solution is more than 20% by weight, it will be difficult to dissolve the lithium salt at the desired concentration in the polymer solution, the viscosity will be high, and the solubility will be low, which makes it difficult to coat the lithium salt in the form of a uniform thin film.

The substrate is not particularly limited as long as it can function as a support for the coating film. For example, the substrate may SUS (stainless use steel), polyethylene terephthalate film, polytetrafluoroethylene film, polyethylene film, polypropylene film, polybutene film, polybutadiene film, vinyl chloride copolymer film, polyurethane film, ethylene-vinylacetate film, ethylene-propylene copolymer film, ethylene-ethyl acrylate copolymer film, ethylene-methyl acrylate copolymer film or polyimide film.

Further, the coating method is not particularly limited as long as it can form a coating film by coating the polymer solution onto the substrate. For example, the coating method may be bar coating, roll coating, spin coating, slit coating, die coating, blade coating, comma coating, slot die coating, lip coating, spray coating or solution casting.

The coating film formed on the substrate by the coating method can be molded into a polymer from which the residual solvent is completely removed through a drying process. The drying can be performed separately by a first drying process and a second drying process in order to prevent shrinkage of the polymer due to rapid evaporation of the solvent. The first drying process can remove part of the solvent through room temperature drying, and the second drying process can completely remove the solvent through vacuum high temperature drying. The high temperature drying may be performed at a temperature of 80° C. to 130° C. If the high-temperature drying temperature is less than 80° C., the residual solvent cannot be completely removed, and if the high-temperature drying temperature is more than 130° C., the polymer shrinks which makes it difficult to form uniform electrolyte membranes.

Additionally, the crosslinking agent may form a bond with the crosslinkable functional group. Descriptions of the type of crosslinking agent, the content of the crosslinking agent, and the type of bond with the crosslinking functional groups are as described above.

Moreover, the initiator may induce a radical polymerization reaction between the crosslinkable functional groups to form a crosslinking bond between the crosslinkable functional groups. The functional group that enables the radical polymerization reaction may be a functional group containing vinyl at the end, for example, an allyl group.

The initiator is not particularly limited as long as it is an initiator that can induce a radical polymerization reaction between the crosslinkable functional groups. For example, the initiator may include one or more selected from the group consisting of benzoyl peroxide, azobisisobutyronitrile, lauroyl peroxide, cumene hydroperoxide, diisopropylphenyl-hydroperoxide, tert-butyl hydroperoxide, p-methane hydroperoxide and 2,2′-azobis(2-methylpropionitrile). The initiator may include a combination of initiators selected from the above-mentioned group.

The initiator may be used in an amount of 0.5 to 2 parts by weight based on 100 parts by weight of the PEO-based copolymer containing crosslinkable functional groups. When the initiator is used within the above range, it can make it possible to induce a radical polymerization reaction between the crosslinkable functional groups and efficiently form a crosslinking bond.

In the step (S3) described in any of the first through third embodiments herein, a polar compound may be vapor deposited onto the polymer or polymer mixture including the crosslinked polymer prepared in the steps (S1)-(S2) to prepare a composite solid electrolyte. By the step (S3), polar compound gas molecules are bound to the polymer chain, or the polar compound in a gaseous state is included in the internal space of the polymer chain, for example, in a network structure (e.g., three-dimensional network structure). The polar compound, and the amount utilized, are as described elsewhere herein.

The vapor deposition may be performed by contacting the polymer with vapor of the polar compound generated at room temperature or by heating the polar compound and penetrating into the polymer. The vapor disposition at room temperature or through heating results in the polar compound in the gaseous state being uniformly diffused on the surface of and/or inside the polymer, so that the polar compound gas molecules are bound to the polymer chain, or a polar compound in a gaseous state is included in the internal space of the polymer chain, for example, in a network structure (e.g. three-dimensional network structure).

With regard to vapor deposition at room temperature, when the polar compound is left at room temperature, a small amount of the polar compound with a low boiling point is slowly vaporized at room temperature and penetrates into the polymer, effectively inducing a change in the conformation of the crosslinked polymer chain within the polymer.

Additionally, when heating a polar compound during vapor deposition, the vapor deposition rate can be improved. The heating temperature is not particularly limited as long as it is a temperature at which the polar compound can change phase into vapor, and may be, for example, 30° C. to 80° C. Normally, PEO melts at 60° C., but the PEO-based copolymers modified with the crosslinking functional group(s) of the present disclosure have improved heat resistance, and can withstand temperatures up to 80° C., allowing the vapor deposition rate to be faster. Additionally, the heating method is not limited to any method that can supply energy to generate vapor. For example, a direct heating method using a burner or stove, or an indirect heating method using a heater or steam pipe, etc. can be used, but the method is not limited to these examples.

When heating at an excessively high temperature, the polar compound above the boiling point may boil, the structure of the polar compound may change, or the polymer may be deformed. This is disadvantageous in that it is difficult to control the evaporation rate of the polar compound during vapor deposition, and therefore vapor deposition of a small amount of polar solvent is difficult to achieve. Thus, it is desirable to carry out vapor deposition at a heating temperature in the appropriate range as specified above.

A further aspect of the present disclosure also relates to an electrode assembly and a solid-state battery (e.g. an all-solid-state-battery) including the electrolyte described herein. For example, according to one illustrative embodiment, a solid-state battery includes a positive electrode (e.g. cathode), a negative electrode (e.g. anode), and the above described electrolyte (e.g. composite solid electrolyte) between the positive electrode and the negative electrode. According to one embodiment, a further aspect of the present disclosure also relates to an electrode assembly and an all-solid-state battery including the electrolyte described herein, as well as a positive electrode comprising a positive electrode active material and a binder comprising the polymer network including the polyethylene oxide-based copolymer having the crosslinkable functional groups.

Specifically, according to one embodiment, the electrolyte includes a crosslinked polymer of a PEO-based copolymer containing crosslinkable functional groups, a non-crosslinkable PEO-based copolymer, and a polar compound in a gaseous state, and further includes a ceramic compound uniformly dispersed therein, and thereby exhibiting improved ionic conductivity, which makes the electrolyte suitable for use in a solid-state battery. According to another embodiment, the electrolyte is a PEO-based copolymer containing a crosslinkable functional group. It includes a polymer crosslinked through a crosslinking agent and a polar compound in the gaseous state, and the polar compound in the gaseous state is included or combined. The electrolyte optionally includes a ceramic compound that is uniformly dispersed therein, thus exhibiting improved ionic conductivity. The electrolyte may thus be suitable for use in an all-solid-state battery.

The positive electrode included in the solid-state battery includes a positive electrode active material layer, and the positive active material layer may be formed on one side of the positive electrode current collector.

The positive electrode active material layer includes a positive electrode active material, a binder, and a conductive material.

The positive electrode active material is not particularly limited as long as it is a material capable of reversibly absorbing and desorbing lithium ions, and examples thereof may be a layered compound, such as lithium cobalt oxide, lithium nickel oxide, Li[NiₓCo_{y}Mn_{z}Mᵥ]O₂ (where M is any one selected from the group consisting of Al, Ga, and In, or two or more elements thereof; and 0.3≤x<1.0, 0≤y, z≤0.5, 0≤v≤0.1, and x+y+z+v=1), Li(LiₐM_{b-a-b′}M′_{b′})O_{2-c}A_{c} (where 0≤a≤0.2, 0.6≤b≤1, 0≤b′≤0.2, and 0≤c≤0.2; M includes Mn and at least one selected from the group consisting of Ni, Co, Fe, Cr, V, Cu, Zn, and Ti; M′ is at least one selected from the group consisting of Al, Mg, and B; and A is at least one selected from the group consisting of P, F, S, and N), or a compound substituted with at least one transition metal; lithium manganese oxides such as the chemical formula Li_{1+y}Mn_{2-y}O₄ (where y ranges from 0 to 0.33), LiMnO₃, LiMn₂O₃, and LiMnO₂; lithium copper oxide (Li₂CuO₂); vanadium oxides such as LiV₃O₈, LiFe₃O₄, V₂O₅, and Cu₂V₂O₇; Ni-site type lithium nickel oxide expressed by the chemical formula LiNi_{1-y}M_{y}O₂ (where M is Co, Mn, Al, Cu, Fe, Mg, B, or Ga, and y ranges from 0.01 to 0.3); lithium manganese complex oxide expressed by the chemical formula LiMn_{2-y}M_{y}O₂ (where M is Co, Ni, Fe, Cr, Zn, or Ta, and y ranges from 0.01 to 0.1) or Li₂Mn₃MOs (where M is Fe, Co, Ni, Cu, or Zn); LiMn₂O₄ having a part of Li being substituted with alkaline earth metal ions; a disulfide compound; and a complex oxide formed of Fe₂(MoO₄)₃, but are not limited thereto.

Further, the positive electrode active material may be included in an amount of 40 to 80% by weight, based on the total weight of the positive electrode active material layer. Specifically, the content of the positive electrode active material may be 40% by weight or more or 50% by weight or more, and 70% by weight or less or 80% by weight or less. If the content of the positive electrode active material is less than 40% by weight, the connectivity and electrical properties between positive electrode active materials may be insufficient, and if the content of the positive electrode active material is more than 80% by weight, the mass transfer resistance may increase.

The binder is a component assisting in binding between the positive electrode active material and the conductive material, and in binding with the current collector. The binder may include one or more selected from the group consisting of styrene-butadiene rubber, acrylic styrene-butadiene rubber, acrylonitrile copolymer, acrylonitrile-butadiene rubber, nitrile butadiene rubber, acrylonitrile-styrene-butadiene copolymer, acrylic rubber, butyl rubber, fluorine rubber, polytetrafluoroethylene, polyethylene, polypropylene, ethylene/propylene copolymer, polybutadiene, polyethylene oxide, chlorosulfonated polyethylene, polyvinylpyrrolidone, polyvinylpyridine, polyvinyl alcohol, polyvinyl acetate, polyepicchlorohydrin, polyphosphazene, polyacrylonitrile, polystyrene, latex, acrylic resin, phenolic resin, epoxy resin, carboxymethylcellulose, hydroxypropyl cellulose, cellulose acetate, cellulose acetate butyrate, cellulose acetate propionate, cyanoethyl cellulose, cyanoethyl sucrose, polyester, polyamide, polyether, polyimide, polycarboxylate, polycarboxylic acid, polyacrylic acid, polyacrylate, lithium polyacrylate, polymethacrylic acid, polymethacrylate, polyacrylamide, polyurethane, polyvinylidene fluoride and poly(vinylidene fluoride)-hexafluoropropene. Preferably, the binder may include one or more selected from the group consisting of styrene-butadiene rubber, polytetrafluoroethylene, carboxymethylcellulose, polyacrylic acid, lithium polyacrylate and polyvinylidene fluoride.

According to one specific embodiment, the binder may include the PEO-based copolymer having the same type of or the same crosslinkable functional group as that included in the composite solid electrolyte of the one embodiment as described above as a main component. Since the binder of the same kind as the composite solid electrolyte layer is included in the anode active material layer, the solid battery above may exhibit excellent mechanical properties along with excellent charge and discharge characteristics and ion conductivity. According to one embodiment, the binder may include the above-described cross-inked PEO copolymer as a component that assists in the bonding of the anode active material and the conductive material and the bonding to the current collector. However, in addition to these copolymers, it is possible to include more common binders. Specifically, the PEO-based copolymer having crosslinkable functional groups may be included in an amount of 60% by weight or more, or 80% by weight or more, or 90-100% by weight based on the total weight of the binder.

In one embodiment, the binder may include as a principal component a PEO copolymer having a crosslinked functional group homogeneous or identical to that contained in the electrolyte. In this way, as the solid electrolyte layer and homogeneous binder are included in the anode active material layer, the solid cell can exhibit excellent mechanical properties, along with excellent charge, discharge properties and ionic conductivity. In a more specific example, a PEO copolymer having a crosslinked functional group may be included in a proportion of more than 60% by weight, or more than 80% by weight, or at a rate of 90 to 100% by weight of the total binder.

The binder may be included in an amount of 1% by weight to 30% by weight, based on the total weight of the positive electrode active material layer. Specifically, the content of the binder may be 1% by weight or more or 3% by weight or more, and 15% by weight or less or 30% by weight or less. If the content of the binder is less than 1% by weight, the adhesion between the positive electrode active material and the positive electrode current collector may decrease, and if the content of the binder is more than 30% by weight, the adhesion is improved, but the content of the positive electrode active material is reduced accordingly, which may lower battery capacity.

The conductive material is not particularly limited as long as it does not cause side reactions in the internal environment of the battery and does not cause chemical changes in the battery but has excellent electrical conductivity. The conductive material may typically be graphite or electrically conductive carbon, and may be, for example, but is not limited to, one selected from the group consisting of graphite such as natural graphite or artificial graphite; carbon black such as carbon black, acetylene black, Ketjen black, Denka black, thermal black, channel black, furnace black, lamp black, and summer black; carbon-based materials whose crystal structure is graphene or graphite; electrically conductive fibers such as carbon fibers and metal fibers; carbon fluoride; metal powders such as aluminum and nickel powder; electrically conductive whiskers such as zinc oxide and potassium titanate; electrically conductive oxides such as titanium oxide; electrically conductive polymers such as polyphenylene derivatives; and a mixture of two or more thereof.

The conductive material may typically be included in an amount of 0.5% to 30% by weight, based on the total weight of the positive electrode active material layer. Specifically, the content of the conductive material may be 0.5% by weight or more or 1% by weight or more, and 20% by weight or less, or 30% by weight or less. If the content of the conductive material is too low, that is, less than 0.5% by weight, it is difficult to obtain an effect on the improvement of the electrical conductivity, or the electrochemical characteristics of the battery may be deteriorated. If the content of the conductive material too high, that is, more than 30% by weight, the amount of positive electrode active material is relatively small and thus capacity and energy density may be lowered. The method of incorporating the conductive material into the positive electrode is not particularly limited, and conventional methods known in the related art such as coating on the positive electrode active material can be used.

In addition, the positive electrode current collector supports the positive electrode active material layer and serves to transfer electrons between the external conductor and the positive electrode active material layer.

The positive electrode current collector is not particularly limited so long as it does not cause chemical changes in the solid-state battery and has conductivity. For example, the positive electrode current collector may be made of copper, stainless steel, aluminum, nickel, titanium, palladium, fired carbon, copper or stainless steel that is surface-treated with one of carbon, nickel, titanium, silver, or the like, an aluminum-cadmium alloy, or the like.

The positive electrode current collector may have a fine protrusion and depression structure layer or may adopt a three-dimensional porous structure in order to improve bonding strength with the positive electrode active material layer. Thereby, the positive electrode current collector may be used in any of various forms including a film, a sheet, a foil, a mesh, a net, a porous body, a foaming body, and a non-woven fabric structure.

The positive electrode as described above can be prepared according to conventional methods. Specifically, the positive electrode can be prepared by a process in which a composition for forming a positive electrode active material layer, which is prepared by mixing a positive electrode active material, a conductive material, and a binder in an organic solvent, is coated and dried on a positive electrode current collector, and optionally, compression molding is performed on the current collector to improve the electrode density. At this time, as the organic solvent, a solvent that can uniformly disperse the positive electrode active material, binder, and conductive material, and that evaporates easily, is preferably used. Specifically, acetonitrile, methanol, ethanol, tetrahydrofuran, water, isopropyl alcohol, dimethyl sulfoxide (DMSO), N-methyl-2-pyrrolidone (NMP), and the like can be mentioned.

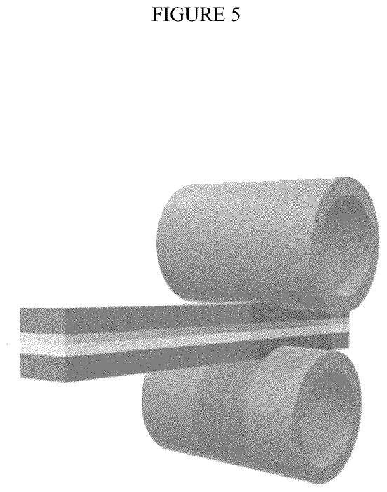

According to one embodiment, the positive electrode optionally satisfies the thickness strain relationship defined by Equation 4 below when rolled on both sides using a roll, as illustrated in FIG. 5:

$$\frac{d}{{d}_{0}} = {C ( \frac{{δ}_{0}}{δ} )}^{- n} \qquad Equation 4$$

wherein in Equation 4 above, δ₀ and d₀ indicates the initial roll gap and initial thickness of the positive electrode before rolling, δ and d represents the roll gap and the thickness of the positive electrode during rolling, C is a constant determined by regression analysis.

The negative electrode contained in the solid-state battery includes a negative electrode active material layer, and the negative electrode active material layer may be formed on one surface of the negative electrode current collector.

In another example of the solid-state battery, the negative electrode (anode) may include only a negative electrode current collector without a negative electrode active material layer. In this case, lithium ions moved from the positive electrode (cathode) during the charging and discharging process of the battery may be deposited on the negative electrode current collector to form a lithium metal layer, and this lithium metal layer can act as a negative electrode active material.

The negative electrode active material may include a material capable of reversible intercalation and deintercalation of lithium (L⁺), a material that can react with lithium ions to reversibly form a lithium-containing compound, lithium metal or lithium alloy.

The material capable of reversibly intercalating or deintercalating lithium ions (Li⁺) may be, for example, crystalline carbon, amorphous carbon, or a mixture thereof. The material that can react with the lithium ion (Li⁺) to reversibly form a lithium-containing compound may be, for example, tin oxide, titanium nitrate, or silicon. The lithium alloy, for example, may be an alloy of lithium (Li) and a metal selected from the group consisting of sodium (Na), potassium (K), rubidium (Rb), cesium (Cs), francium (Fr), beryllium (Be), magnesium (Mg), calcium (Ca), strontium (Sr), barium (Ba), radium (Ra), aluminum (Al), and tin (Sn).

Preferably, the negative electrode active material may be lithium metal, and specifically, may be in the form of a lithium metal thin film or lithium metal powder.

The negative electrode active material may be included in an amount of 40 to 80% by weight based on the total weight of the negative electrode active material layer. Specifically, the content of the negative electrode active material may be 40% by weight or more or 50% by weight or more, and 70% by weight or less or 80% by weight or less. When the content of the negative electrode active material is less than 40% by weight, the electrical properties may be not sufficient, and if the content of the negative electrode active material is more than 80% by weight, the mass transfer resistance may increase.

According to certain embodiments, the negative electrode layer binder may be of the same type and amount as the positive electrode binder, previously described herein.

Further, the conductive material is the same as described above for the positive electrode active material layer.

The negative electrode current collector is not particularly limited so long as it does not cause chemical changes in the corresponding battery and has conductivity. For example, the negative electrode current collector may be made of copper, stainless steel, aluminum, nickel, titanium, fired carbon, copper or stainless steel that is surface-treated with one of carbon, nickel, titanium, silver, or the like, an aluminum-cadmium alloy, or the like. Further, similar to the positive electrode current collector, the negative electrode current collector may be used in various forms such as a film, a sheet, a foil, a net, a porous body, a foaming body, and a non-woven fabric structure, which fine protrusions and depressions are formed on a surface thereof.

The preparation method of the negative electrode is not particularly limited, and it can be prepared by forming a negative electrode active material layer on a negative electrode current collector using a layer or film forming method commonly used in the art. For example, methods such as compression, coating, and deposition can be used. Further, the negative electrode of the present disclosure also includes a case in which a battery is assembled in a state where a lithium thin film does not exist on the negative electrode current collector, and then a metallic lithium thin film is formed on a metal plate through initial charging.

According to still another embodiment, there are provided a battery module including the solid state battery as a unit cell, a battery pack including the battery module, and a device including the battery pack as a power source.

Specific examples of the device may include, but are not limited to power tools driven by an electric motor; electric cars, including electric vehicles (EV), hybrid electric vehicles (HEV), plug-in hybrid electric vehicles (PHEV), or the like; electric carts, including electric bikes (E-bikes) and electric scooters (E-scooters); electric golf carts; electric power storage systems; or the like.

In view of the above, it will be seen that the several advantages of the invention are achieved, and other advantages attained.

Hereinafter, preferred examples are presented to help understand the invention, but the following examples are provided only to make the invention easier to understand and the invention is not limited thereto.

### EXAMPLES

Examples 1 to 3 and Comparative Examples 1 to 3: Preparation of Composite Solid Electrolyte

A PEO-based copolymer including crosslinkable functional groups of the following Formula 1a was prepared.

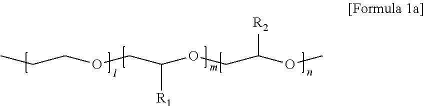

In Formula 1a, R₁ is —CH₂—O—(CH₂CH₂O)ₖ—CH₃, R₂ is —CH₂—O—CH₂—CH═CH₂, k is 2, the ratio of l:m:n is 85:13:2, and the weight average molecular weight (Mw) of the copolymer is about 2,000,000 g/mol.

The copolymer of Formula 1a has an allyl group bonded through a methylene oxide linker as a crosslinkable functional group.

A non-crosslinkable PEO-based copolymer of the following Formula 1b was prepared.

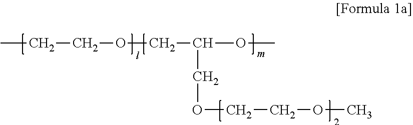

In Formula 1b, the ratio of l:m is 85:15, and the weight average molecular weight (Mw) of the copolymer is about 2,000,000 g/mol.

In Examples and Comparative Examples, the non-crosslinkable PEO-based copolymer of Chemical Formula 1b was used to meet the following weight ratio of the weight of the non-crosslinkable PEO-based copolymer of Chemical Formula 1b to the total weight of the PEO-based copolymer including crosslinkable functional groups of Chemical Formula 1a and the non-crosslinkable PEO-based copolymer of Chemical Formula 1b, 0:1 (Comparative Example 1), 0.15:1 (Example 1), 0.3:1 (Example 2), 0.5:1 (Example 3), 0.7:1 (Comparative Example 2), and 1:1 (Comparative Example 3), and the PEO-based copolymer including crosslinkable functional groups of Chemical Formula 1a was used at the remaining weight ratios from the above. The polymer mixtures were prepared by mixing the copolymers of Chemical Formulas 1a and 1b at the above described weight ratios. In other words, for example, the weight ratio of the PEO-based copolymer containing crosslinkable functional groups of Chemical Formula 1a to the non-crosslinkable PEO-based copolymer of Chemical Formula 1b in the polymer mixture of Example 3 is 5:5.

The polymer mixture prepared above was added to acetonitrile, which was used as a solvent, and trimethylolpropane trimethacrylate used as a crosslinking agent, benzoyl peroxide used as an initiator, a lithium salt, LiTFSI, and LSTP used as a ceramic compound were added thereto and mixed together to prepare a mixed solution of the above mentioned PEO-based copolymers and ceramic compound. The mixed solution was then stirred using a magnetic bar for 24 hours. When preparing the above mixed solution, 36 parts by weight of the lithium salt (LiTFSI) and 40 parts by weight of the ceramic compound (LSTP) based on 100 parts by weight of the polymer mixture were mixed. In addition, When preparing the above mixed solution, 36 parts by weight of the lithium salt, LiTFSI, and 40 parts by weight of the ceramic compound, LSTP, based on 100 parts by weight of the polymer mixture were mixed. In addition, 20 parts by weight of the crosslinking agent, trimethylolpropane trimethacrylate, and 1 part by weight of the initiator, benzoyl peroxide, based on 100 parts by weight of the PEO-based copolymer having crosslinking functional groups of Formula 1a in the mixed solution were added and mixed. The amount of the acetonitrile solvent was adjusted such that the content of the polymer mixture in the mixed solution was 11.1% by weight and the content of the polymer mixture and the ceramic compound was 14.9% by weight.

The mixed solution prepared above was cast on a lower substrate of a coin cell, was subjected to a first drying at room temperature for 12 hours, and then was subjected to a second drying in a vacuum oven at 100° C. for 12 hours to prepare an electrolyte film having a thickness of 200 μm.

The electrolyte film was attached to a top of a chamber, a bottom of the chamber was filled with ethylmethyl carbonate (EMC), and EMC was naturally evaporated at room temperature for 72 hours to allow EMC vapor to flow into the electrolyte film attached to the top of the chamber. The composite solid electrolyte was thus prepared by vapor deposition of EMC onto the polymer film.

### Comparative Examples 4 to 9 (without Vapor Deposition)

Composite solid electrolytes of Comparative Examples 4, 5, 6, 7, 8, and 9 were prepared in the same manner as Comparative Example 1(weight ratio 0:1), Example 1(weight ratio 0.15:1), Example 2(weight ratio 0.3:1), Example 3(weight ratio 0.5:1), Comparative Example 2(weight ratio 0.7:1), and Comparative Example 3(weight ratio 1:1), respectively, except that the step of vapor deposition of EMC was not performed.

### Examples 4 to 6 and Comparative Examples 10 to 18: Preparation of Composite Solid Electrolyte

A (PEO)-based copolymer of the following Formula 1a was prepared:

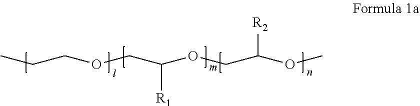

In Formula 1a, R₁ is —CH₂—O—(CH₂CH₂O)ₖ—CH₃, R₂ is —CH₂—O—CH₂—CH═CH₂, k is 2, The ratio of l:m:n is 85:13:2. The weight average molecular weight (Mw) of the copolymer was about 2,000,000 g/mol.

The copolymer of Formula 1a has an allyl group bonded through a methylene oxide linker as a crosslinkable functional group.

Acetonitrile was used as a solvent, trimethylolpropane trimethacrylate was used as a crosslinking agent, benzoyl peroxide was used as an initiator, a lithium salt LiTFSI was mixed with LSTP as a ceramic compound to prepare a mixed solution of the above-mentioned (PEO)-based copolymer and ceramic compound, and then stirred using a magnetic bar for 24 hours. The mixed solution contained, based on 100 parts by weights of the copolymer, 1 part by weight of benzoyl peroxide 36 parts by weight of lithium salt LiTFSI, 40 parts by weight of LSTP, a ceramic compound. The weight ratio of the crosslinking agent, based on 100 parts by weight of the copolymer was 20 parts by weight (Comparative Example 16), 15 parts by weight (Example 4), 10 parts by weight (Example 5), 8 parts by weight (Example 6), 5 parts by weight (Comparative Example 17), 0 parts by weight (Comparative Example 18).

The concentration of the copolymer in the mixed solution was 11.1% by weight, and the amount of acetonitrile solvent was adjusted so that the concentration of the copolymer and ceramic compound was 14.9% by weight.

The prepared mixed solution was cast on a coin cell lower substrate, first dried at room temperature for 12 hours, and then secondarily dried in a vacuum oven at 100° C. for 12 hours to form a 200 μm thick layer. An electrolyte film was thus prepared.

The electrolyte film was attached to the top of the chamber, the bottom of the chamber was filled with ethylmethyl carbonate (EMC) solvent, and it was naturally evaporated at room temperature for 72 hours to allow EMC vapor to flow into the electrolyte film attached to the top of the chamber. The composite solid electrolyte was thus prepared by vapor deposition of EMC onto the polymer composite film.

### Comparative Examples 10 to 15

Composite solid electrolytes were prepared in the same manner as those prepared in Examples 4 to 6 and Comparative Examples 16 to 18, except that the step of vapor deposition of the EMC solvent was not performed in Example 4.

During the preparation of Comparative Examples 10-15, the mixing weight ratio of the crosslinking agent per 100 parts by weight of the copolymer is, 20 parts by weight (Comparative Example 10), 15 parts by weight (Comparative Example 11), 10 parts by weight (Comparative Example 12), 8 parts by weight (Comparative Example 13), 5 parts by weight (Comparative Example 14), 0 parts by weight (Comparative Example 15).

### Example 7 and Comparative Example 19

### Example 7: Preparation of Composite Solid Electrolyte and all-Solid-State Battery

### Step 1) Preparation of Polymer Containing Copolymer

A polyethylene oxide (PEO)-based copolymer of the following formula 1a was prepared:

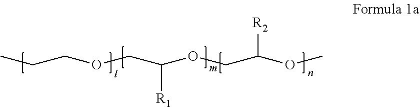

In Formula 1a, R₁ is —CH₂O—(CH₂—CH₂—O)ₖ—CH₃, R₂ is —CH₂—O—CH₂—CH═CH₂, k is 2, The ratio of l:m:n is 85:13:2, and the weight average molecular weight (Mw) of the copolymer was about 2,000,000 g/mol.

The copolymer of Formula 1a has an allyl group as a crosslinkable functional group bonded through a methylene oxide linker.

A mixture was formed with the polyethylene oxide (PEO)-based copolymer, acetonitrile as a solvent, trimethylolpropane trimethacrylate as a crosslinking agent, benzoyl peroxide as an initiator, lithium salt LiTFSI, and LSTP as a ceramic compound. This mixture was stirred using a magnetic bar for 24 hours. At this time, the polyethylene oxide composition of the mixed solution of copolymer and ceramic compound is polyethylene oxide. The mixture was composed such that for 100 parts by weight of the copolymer, 20 parts by weight of trimethylolpropane trimethacrylate, 1 part by weight of benzoyl peroxide, 36 parts by weight of LiTFSI, and 40 parts by weight of LSTP, were included. The concentration of the copolymer in the mixture is 11.1% by weight, and the acetonitrile solvent was used so that the concentration of the copolymer and ceramic compound in the mixture was 14.9% by weight.

After casting the prepared mixture onto the coin cell lower substrate, it was first dried at room temperature for 12 hours and then placed in a vacuum oven at 100° C. for 12 hours. Secondary drying was conducted in a vacuum oven (<10⁻² Torr) at 100° C. for 12 hours to ensure complete removal of residual solvent. The resulting electrolyte membrane had an approximate thickness of 200 μm.

### Step 2) Preparation of Composite Solid Electrolyte

The polymer is attached to the upper plate of the chamber, the lower part of the chamber is filled with ethyl methyl carbonate (EMC) solvent, and then it is naturally evaporated at room temperature for 72 hours. The EMC vapor is introduced into the inside of the polymer attached to the upper part of the chamber and deposited on the polymer. Thus, a composite solid electrolyte was prepared.

### Step 3) Manufacturing of all-Solid-State Battery (Electrode Assembly)

NCMA (LiNi_{0.85}Co_{0.05}Mn_{0.05}Al_{0.02}O₂) as positive electrode active material particles (particle size: 5-10 μm, LG CHEM, Republic of Korea), superconductive carbon (C-65) conducting material, crosslinked PEO-based copolymer of formula 1a as used in step 1, LiTFSI were combined in a weight ratio of 77.6:3:14.2:5.2 and added to an acetonitrile solvent. The mixture was stirred using a paste mixer at 1500 rpm for 3 minutes at room temperature 5 times. The prepared mixed solution was cast on aluminum foil, first dried at room temperature for 6 hours, and then secondarily dried at 100° C. for 12 hours to prepare a positive electrode film with a thickness of 60 m. After punching the positive electrode film with a mass loading of 6.712 mg/cm², the prepared composite solid electrolyte was used as the electrolyte film and lithium metal foil (300 μm) was used as the negative electrode, and the coin cell was manufactured by stacking them in a sandwich type.

### Comparative Example 9: Manufacturing of Composite Solid Electrolyte and all-Solid-State Battery

A composite solid electrolyte and an all-solid-state battery were manufactured in the same manner as those manufactured in Example 7, except that step 2) of vapor deposition of the EMC solvent in Example 7 was not performed.

### Experiment Examples

### Experimental Example 1: Measurement of Content of Polar Compound

The content of the polar compound can be measured by using a scale to monitor the weight loss from a composite solid electrolyte specimen by evaporation of the polar compound over time while heating the composite solid electrolyte specimen. For example, the weight of the polar compound released from the specimen by evaporation over time can be monitored during heating the specimen at a temperature of 55° C. to 70° C. or at 60° C. using a heated electronic scale (A&D MS-70 moisture analyzer). When the amount reached saturation point, the point where no more weight loss is monitored, the saturation amount at that time was regarded as the total amount of polar compound contained within the composite solid electrolyte. In Examples and Comparative Examples, the polar compound may be ethylmethyl carbonate (EMC).

### Experimental Example 2: Measurement of Ion Conductivity of Composite Solid Electrolyte

In order to measure the ionic conductivity of the composite solid electrolyte prepared in Examples and Comparative Examples, the composite solid electrolyte was formed on the lower substrate of the coin cell with a size of 1.7671 cm² and then SUS was used as an inactive electrode (blocking electrode) to prepare the coin cell for measuring the ionic conductivity.

Resistance was measured using an electrochemical impedance spectrometer (EIS, VM3, Bio Logic Science Instrument) at 25° C. with an amplitude of 10 mV and a scan range of 1 Hz to 0.1 MHz, and then the ionic conductivity of the composite solid electrolyte was calculated using Equation 1 below.

$${σ}_{i} = \frac{L}{RA} \qquad Equation 1$$

In Equation 1, σᵢ is the ionic conductivity of the composite solid electrolyte (S/cm), R is the resistance (Ω) of the composite solid electrolyte measured with the electrochemical impedance spectrometer, and L is the thickness of the composite solid electrolyte (in μm), and A is the area of the composite solid electrolyte (in cm²). The composite solid electrolyte sample with L=200 μm and A=1.7671 cm² was used.

### Experiment Example 3: Measurement of Activation Energy by Temperature of Composite Solid Electrolyte Layer

Measuring the ionic conductivity of the composite solid electrolyte film at each temperature, by fitting the relationship between log (σᵢ) and 1000/T using the Arrhenius equation below, Eₐ corresponding to the slope is calculated.

$${σ}_{i} = {σ}_{i , 0} exp [ - \frac{{E}_{a}}{R T} ]$$

In the above equation σ_{i,0} is the maximum ionic conductivity of the solid electrolyte, Eₐ is the activation energy, R is the gas constant, and T is the absolute temperature.

### Experiment Example 4: Evaluation of Thickness Strain Rate During Rolling for Anode

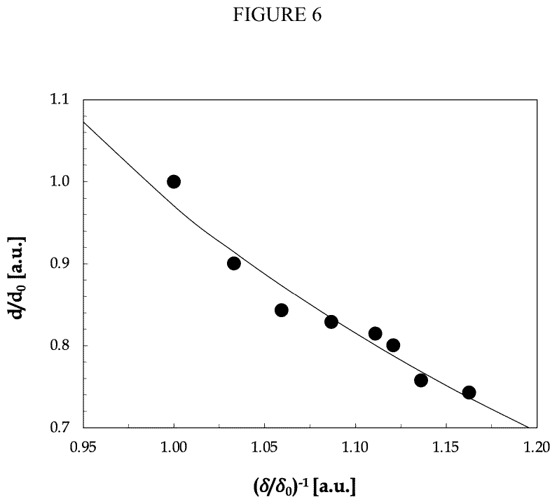

The positive electrode film with a thickness of 60 μm prepared in Example 7 was passed through a roll-to-roll mill and roll pressed to reduce the voids between active materials. The gap of the nip roll was gradually reduced and the thickness of the anode film at each gap was measured to summarize the relationship between the roll gap ratio and the anode film thickness ratio as shown in FIG. 6.

### Experiment Example 5: Charge/Discharge Test for all-Solid-State Battery

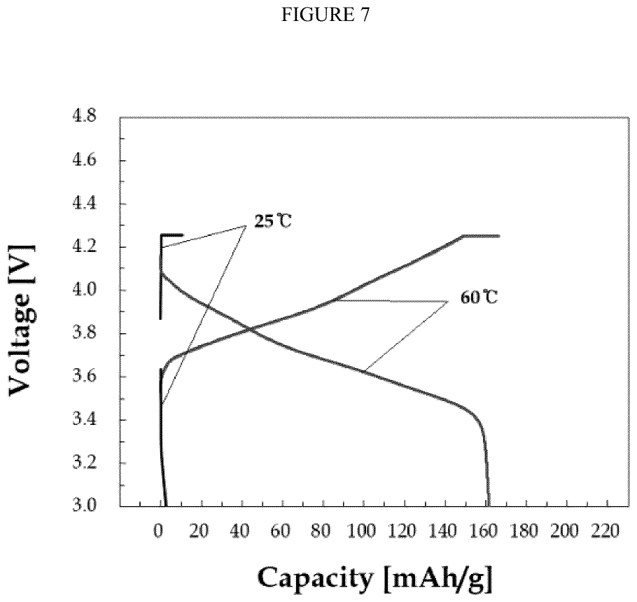

To evaluate the galvanostatic cycling characteristics of the manufactured all-solid-state battery, charging and discharging of the battery was repeated in the voltage range of 3.0-4.25 V using a TOSCAT charge/discharge tester (TOYO SYSTEM Co. Ltd., Japan). The charge/discharge test of the all-solid-state battery composite solid electrolyte of Example 7 was conducted at room temperature (25° C.) at a charge/discharge rate of 0.03 C, and the all-solid-state battery containing the composite solid electrolyte of the comparative example without a polar solvent was tested at 25° C. and 60° C. Charge and discharge tests were conducted under the same conditions. These results are shown in FIG. 7.

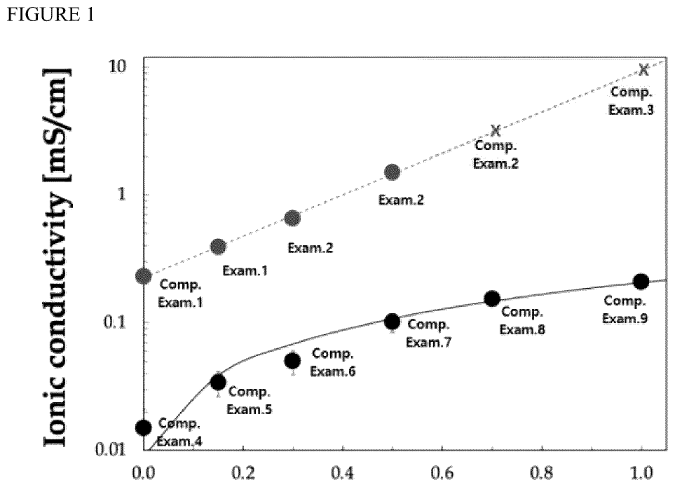

The ionic conductivity of Examples 1-3 and Comparative Examples 1-9 measured in accordance with the above described method are shown in Table 1 below and in FIG. 1.

Referring to FIG. 1, Comparative Examples 4 to 9 are from the composite solid electrolytes prepared without vapor deposition of polar compound (EMC) and exhibited ionic conductivity lower than those of Examples 1 to 3.

In Table 1 below, the ion conductivity of the composite solid electrolytes of Example 3 and Comparative Example 7 measured from low to high temperature in the range of −40° C. to 80° C. are compared. In addition, the drawing shows the results of ion conductivity of Examples 1 to 3 and Comparative Examples 1 to 9 measured at room temperature, 25° C.

TABLE 1

| | |
|---|---|
| Temperature | Ion conductivity (mS/cm) |

| (° C.) | Example 3 | Comparative Example 7 |
|---|---|---|
| −40 | 0.0659 | — (substantively 0) |
| −30 | 0.2080 | 0.000045 |
| −20 | 0.3287 | 0.00039 |
| −10 | 0.5072 | 0.0042 |
| 0 | 0.7746 | 0.0214 |
| 10 | 1.9713 | 0.053 |
| 20 | 2.4333 | 0.2053 |
| 25 | 2.7386 | 0.2584 |
| 30 | 2.9961 | 0.3483 |
| 40 | 3.4330 | 0.6506 |
| 50 | 4.0431 | 0.9592 |
| 60 | 4.6308 | 2.4997 |
| 70 | 6.5933 | 3.3221 |
| 80 | 7.0315 | 4.2592 |

As shown in Table 1, the electrolyte of Example 3 showed superior ionic conductivity compared to Comparative Example 7 over the entire range of the measurement temperature, even at the low temperature at 0° C. or below.

In addition, it was confirmed that the electrolytes of Comparative Examples 4 to 9, which were prepared without vapor deposition of the polar compound, EMC for example, provided inferior ion conductivities compared to Examples as shown in the drawing.

Further, it was confirmed that Examples 1 to 3 in which the weight ratio of the non-crosslinkable PEO-based copolymer was optimized showed excellent ion conductivity, while Comparative Examples 2 and 3 in which the weight ratio of the non-crosslinkable PEO-based copolymer was excessively high could not be measured (shaded area in the drawing), and Comparative Example 1 in which the weight ratio of the non-crosslinkable PEO-based copolymer was excessively low also showed lower ion conductivity than those of Examples.

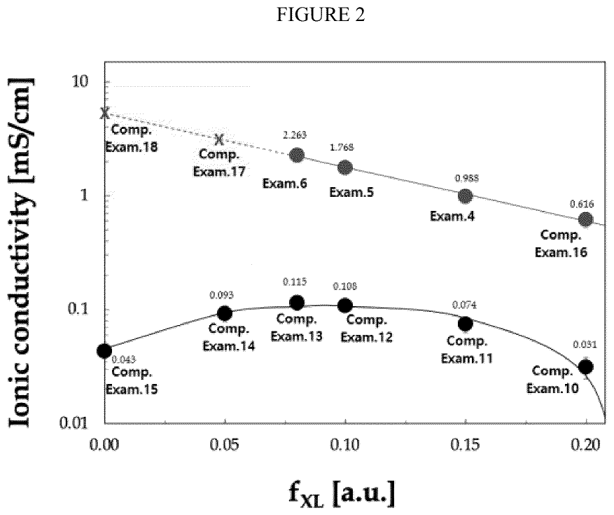

The ionic conductivity evaluation results of Examples 4-6 and Comparative Examples 10-18 measured as above are shown in FIG. 2.

Referring to FIG. 2, Comparative Example 10 to 15 are composite solid electrolytes prepared without vapor deposition of polar compounds (EMC). It was confirmed that the ionic conductivity was lower than that of the Examples 4-6.

Also, Examples 4-6, in which the weight ratio of the crosslinking agent was optimized, showed excellent ionic conductivity. Comparative Examples 17 and 18, where the weight ratio of crosslinking agent is too low, it was confirmed that measurement of ionic conductivity itself was impossible. In Comparative Example 16, where the weight ratio of crosslinking agent is too high, it was also confirmed that this sample exhibits lower ionic conductivity compared to the Examples 4-6.

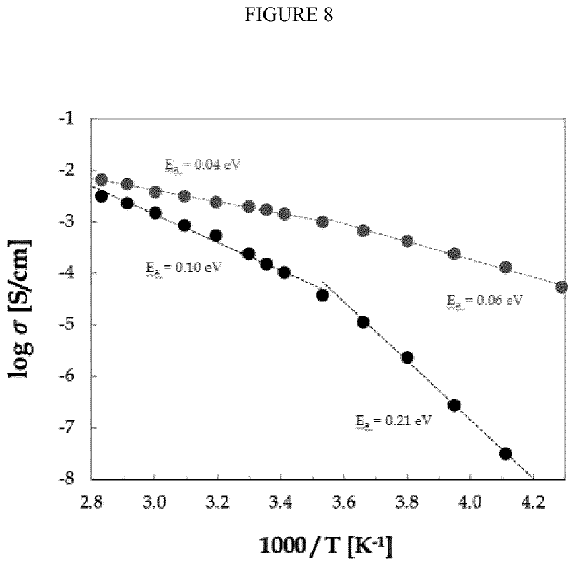

From the measurement and evaluation results of Experiment Examples 2 and 3, the results of evaluating the activation energy and log (ionic conductivity) of the composite solid electrolyte layers included in Example 7 and Comparative Example 19 at each temperature are shown in comparison with FIG. 8.

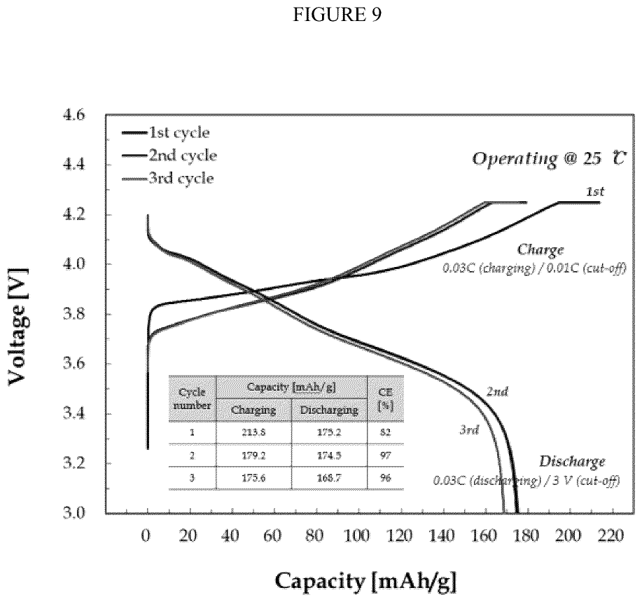

In addition, from the evaluation results of Experiment Example 5, the results of the room temperature charge/discharge test of the all-solid-state battery of Example 7 are shown in FIG. 9. The results of charge/discharge tests of the all-solid-state battery of Comparative Example 19 at room temperature and high temperature (60° C.) are shown in FIG. 7, as noted above.

Referring to FIG. 8, the composite solid electrolyte included in the all-solid-state battery of Example 7 not only has a lower variation in activation energy with temperature compared to Comparative Example 19, it was confirmed that it exhibits excellent ionic conductivity as well.

Also, referring to FIGS. 9 and 7, while the all-solid-state battery of Example 7 shows excellent charge and discharge characteristics at room temperature, it was confirmed that the all-solid-state battery of Comparative Example 19 was practically impossible to operate at room temperature.

As various changes could be made in the above methods and compositions without departing from the scope of the invention, it is intended that all matter contained in the above description shall be interpreted as illustrative and not in a limiting sense.

Any numbers expressing quantities of ingredients, constituents, reaction conditions, and so forth used in the specification are to be interpreted as encompassing the exact numerical values identified herein, as well as being modified in all instances by the term “about.” Notwithstanding that the numerical ranges and parameters setting forth, the broad scope of the subject matter presented herein are approximations, the numerical values set forth are indicated as precisely as possible. Any numerical value, however, may inherently contain certain errors or inaccuracies as evident from the standard deviation found in their respective measurement techniques. None of the features recited herein should be interpreted as invoking 35 U.S.C. § 112, paragraph 6, unless the term “means” is explicitly used.

1. An electrolyte comprising:
a polymer formed of a polyethylene oxide (PEO)-based copolymer containing crosslinkable functional groups;
a ceramic compound; and
a polar compound,
wherein at least some of the crosslinkable functional groups of the PEO-based copolymer containing crosslinkable functional groups form crosslinks with each other.

2. The electrolyte according to claim 1, wherein the polymer is in a polymer mixture including the PEO-based copolymer containing crosslinkable functional groups and a non-crosslinkable polyethylene oxide-based copolymer,
wherein the polar compound is contained in the polymer mixture.

3. The electrolyte according to claim 1, wherein the polymer is in the form of a network structure formed of the PEO-based copolymer, and also includes a crosslinking agent,
wherein at least a portion of the crosslinkable functional groups form crosslinks with the crosslinking agent,
wherein the polar compound is contained in the network structure, and
wherein the crosslinking agent is included at a weight ratio of the crosslinking agent to the polyethylene oxide-based copolymer expressed as:
$${f}_{XL} = \frac{{W}_{XL}}{{W}_{P}} ,$$
wherein W_{XL} is the weight of the crosslinking agent, W_{P} is the weight of the polyethylene oxide-based copolymer, and f_{XL} is 0.07 to 0.19.

4. The electrolyte of claim 1, wherein the electrolyte has an ionic conductivity of 0.15 mS/cm or higher at a temperature of −30° C. or higher.

5. The electrolyte of claim 1, wherein the electrolyte has an ionic conductivity of 0.95 mS/cm or more at 25° C.

6. The electrolyte of claim 2, wherein a weight ratio of the non-crosslinkable PEO-based copolymer to a total weight of the polymer mixture is more than 0 and 0.55 or less.

7. The electrolyte of claim 1, wherein a content of the polar compound is 0.1% by weight or more and less than 10% by weight based on a total weight of the electrolyte.

8. The electrolyte of claim 1, wherein the PEO-based copolymer containing crosslinkable functional groups is in the form of a network structure formed by the crosslinks, and
wherein the polar compound is contained in the network structure.

9. The electrolyte of claim 1, wherein the electrolyte further comprises a crosslinking agent.

10. The electrolyte of claim 9, wherein the at least some of the crosslinkable functional groups form the crosslinks with each other through the crosslinking agent.

11. The electrolyte of claim 9, wherein the crosslinking agent comprises one or more selected from the group consisting of trimethylolpropane trimethacrylate, poly(ethylene glycol) diacrylate, poly(ethylene glycol) dimethacrylate, ethylene glycol dimethylacrylate, (EGDMA), 1,3-diisopropenylbenzene (DIP), 1,4-diacryloyl piperazine, 2-(diethylamino)ethyl methacrylate, 2,6-bisacryloylamidopyridine, 3-(acryloyloxy)-2-hydroxypropyl methacrylate, 3,5-bis(acryloylamido)benzoic acid, 3-aminopropyltriethoxysilane, 3-isocyanatopropyltriethoxysilane, 3-methylacryloxypropyl trimethoxysilane, bis-(1-(tert-butylperoxy)-1-methylethyl)-benzene, dicumyl peroxide, dimethacrylate, divinylbenzene, ethylene glycol maleic rosinate acrylate, glycidilmethacrylate, hydroxyquinoline, i-phenyldiethoxysilane, maleic rosin glycol acrylate), methylene bisacrylamide, N,N′-1,4-phenylenediacrylamine), N,O-bisacryloyl-phenylalaninol), N,O-bismethacryloyl ethanolamine, pentaerythritol triacrylate, phenyltrimethoxy silane, tetramethoxysilane, tetramethylene, tetraethoxysilane, and triallyl isocyanurate.

12. The electrolyte of claim 1, wherein the crosslinkable functional groups are connected to a main chain of the PEO-based copolymer via a direct bond or a linker having 1 to 10 carbon number, and
wherein the crosslinkable functional groups are selected from the group consisting of a hydroxyl group, a carboxyl group, an isocyanate group, a nitro group, a cyano group, an amine group, an amide group, an epoxy group, and an allyl group.

13. The electrolyte of claim 1, wherein the electrolyte further includes a lithium salt.

14. The electrolyte of claim 13, wherein the lithium salt is included in an amount of 25 to 45 parts by weight, based on 100 parts by weight of the PEO-based copolymer containing the crosslinkable functional group.

15. The electrolyte of claim 2, wherein a weight ratio of the PEO-based copolymer containing crosslinkable functional groups to the non-crosslinkable PEO-based copolymer is 5:5 to 9:1.

16. The electrolyte of claim 1, wherein the PEO-based copolymer containing crosslinkable functional groups is a copolymer having repeating units of the following Formulas 1 to 3: 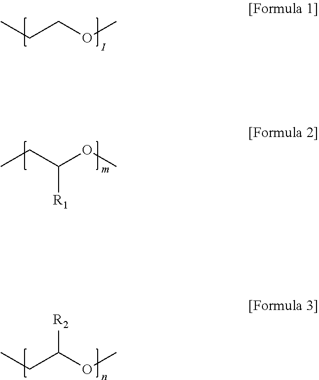
wherein, in Formulas 1 to 3,
R₁ is —CH₂—O—(CH₂—CH₂—O)ₖ—R₃, k is 0 to 20, and R₃ is an alkyl group having 1 to 5 carbon atoms,
R₂ is a group in which one or more crosslinkable functional groups selected from the group consisting of a hydroxyl group, a carboxyl group, an isocyanate group, a nitro group, a cyano group, an amine group, and an amide group, an epoxy group and an allyl group are bonded to a main chain of the PEO-based copolymer via a direct bond or a linker having 1 to 10 carbon number,
l, m, and n are the number of the repeating units, where 1 and n are each independently an integer from 1 to 100,000, and m is an integer from 0 to 100,000.

17. The electrolyte of claim 2, wherein the non-crosslinkable PEO-based copolymer is a copolymer having repeating units of the following Formulas 1 and 2: 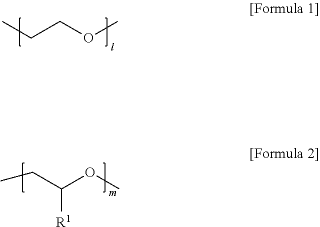
wherein, in Formulas 1 and 2,
R₁ is —CH₂—O—(CH₂—CH₂—O)ₖ—R₃, k is 0 to 20, and R₃ is an alkyl group having 1 to 5 carbon atoms,
l and m are the number of the repeating units, and are each independently an integer from 1 to 100,000.

18. The electrolyte of claim 2, wherein each of the PEO-based copolymer containing crosslinkable functional groups and the non-crosslinkable PEO-based copolymer has a weight average molecular weight (Mw) of 100,000 g/mol to 4,000,000 g/mol.

19. The electrolyte of claim 1, wherein the polar compound includes one or more selected from the group consisting of carbonate-based compounds and sulfonyl-based compounds.

20. The electrolyte of claim 1, wherein the polar compound comprises one or more selected from the group consisting of ethyl methyl carbonate (EMC), dimethyl carbonate (DMC), diethyl carbonate (DEC), ethylene carbonate (EC), propylene carbonate (PC), vinylene carbonate (VC), and sulfolane.

21. The electrolyte of claim 1, wherein the ceramic compound comprises an oxide-based solid electrolyte of lithium metal oxide or lithium metal phosphate.

22. The electrolyte of claim 1, the ceramic compound comprises one or more selected from the group consisting of a lithium-lanthanum-zirconium oxide (LLZO) compound, a lithium-silicon-titanium phosphate based (LSTP) compound, a lithium-lanthanum-titanium oxide based (LLTO) compound, a lithium-aluminum-titanium phosphate based (LATP) compound, a lithium-aluminum-germanium phosphate based (LAGP) compound, and a lithium-lanthanum-zirconium-titanium oxide-based (LLZTO) compound.

23. The electrolyte of claim 1, wherein the ceramic compound is in the form of particles having an average diameter of 100 nm to 1000 nm.

24. The electrolyte of claim 1, wherein the ceramic compound is included in an amount of 10 parts by weight to 100 parts by weight based on 100 parts by weight of the polymer mixture.

25. The electrolyte of claim 1, wherein the polymer comprises a network structure, and the polar compound is dispersed between polymer chains forming the network structure, or is adsorbed or bound to the surface or interior of the polymer chains.

26. The electrolyte of claim 1, wherein the polar compound is in a gaseous state.

27. The electrolyte of claim 1, wherein the crosslinking agent comprises a multifunctional compound having a plurality of curable functional groups selected from the group consisting of: a (meth)acrylic functional group, an alkoxy functional group, a peroxide functional group, a vinyl functional group, a hydroxyl group, an epoxy functional group and an allyl group.

28. A battery comprising the electrolyte of claim 1.

29. A method for preparing an electrolyte, the method comprising:
(S1) preparing a mixture comprising a polymer mixture including a polyethylene(PEO)-based copolymer containing crosslinkable functional groups and a non-crosslinkable PEO-based copolymer, and a ceramic compound;
(S2) performing a crosslinking reaction of the PEO-based copolymer containing crosslinkable functional groups included in the mixture such that at least some of the crosslinkable functional groups of the PEO-based copolymer form crosslinks with each other; and
(S3) vapor-depositing a polar compound onto the result product formed in (S2) including the crosslinked PEO-based copolymer such that the polar compound is contained in the polymer mixture.

30. A method for preparing an electrolyte, the method comprising the steps of:
(S1) preparing a mixture comprising a polyethylene oxide-based copolymer containing a crosslinkable functional group, a crosslinking agent, and a ceramic compound, wherein the mixture comprises a weight ratio of crosslinking agent to polyethylene oxide-based copolymer expressed as:
$${f}_{XL} = \frac{{W}_{XL}}{{W}_{P}} ,$$
wherein W_{XL} is the weight of the crosslinking agent, W_{P} is the weight of the polyethylene oxide-based copolymer, and f_{XL} is 0.07 to 0.19;
(S2) polymerizing the mixture, wherein the polymerization comprises at least a portion of the crosslinkable functional groups forming crosslinks with the crosslinking agent, and the resulting polymer is in the form of a network structure; and
(S3) vapor-depositing a polar solvent onto the polymer prepared in steps (S1)-(S2).

31. The method of claim 30, further comprising adding an initiator at (S1) or (S2).

32. An electrode assembly comprising:
a positive electrode;
a negative electrode; and
an electrolyte layer between the positive electrode and the negative electrode,
wherein the electrolyte layer comprises the electrolyte according to claim 1, and
wherein the positive electrode comprises a positive electrode active material and a binder comprising the polymer including the PEO-based copolymer having the crosslinkable functional groups.

33. The electrode assembly according to claim 32, wherein the electrolyte layer has an activation energy deviation (ΔEₐ) by temperature defined by Equation 2 below of 0.03 eV or less:
$$Δ {E}_{a} = {E}_{a}^{LT} - {E}_{a}^{HT} \qquad Equation 2$$
wherein in Equation 2 above, Eₐ^{LT} is the activation energy of the electrolyte layer at −40° C. to 10° C., Eₐ^{HT} is the activation energy of the electrolyte layer from 10° C. to 80° C., ΔEₐ represents the activation energy deviation by temperature, which is defined as the difference between the two activation energies.

34. The electrode assembly of claim 32, wherein the positive electrode satisfies the thickness strain defined by Equation 4 below when rolled on both sides using a roll:
$$\frac{d}{{d}_{0}} = {C ( \frac{{δ}_{0}}{δ} )}^{- n}$$
wherein in the Equation 4 above, δ₀ and d₀ indicates the initial roll gap and initial thickness of the positive electrode before rolling, δ and d represents the roll gap and the thickness of the positive electrode during rolling, C is a constant determined by regression analysis.

35. The electrode assembly of claim 32, wherein the negative electrode comprises a metal layer.
